(19) United States
(12) Patent Application Publication
(10) Pub. No.: US 2015/0370484 A1
(43) Pub. Date: Dec. 24, 2015

(54) STORAGE DEVICE AND DATA INPUT/OUTPUT METHOD

(71) Applicant: HITACHI, LTD., Chiyoda-ku, Tokyo (JP)

(72) Inventors: Tomohiro KAWAGUCHI, Tokyo (JP); Akira YAMAMOTO, Tokyo (JP); Shigeo HOMMA, Tokyo (JP); Takashi NAGAO, Tokyo (JP)

(73) Assignee: HITACHI, LTD., Chiyoda-ku, Tokyo (JP)

(21) Appl. No.: 14/765,275

(22) PCT Filed: Aug. 20, 2013
(86) PCT No.: PCT/JP2013/072196

§ 371 Date: Jul. 31, 2015

(51) Int. Cl. G06F 3/06

(52) U.S. Cl. CPC G06F 3/0604; G06F 3/0647; G06F 3/0683

(57) ABSTRACT

Proposed are a storage apparatus and a data input/output method capable of improving the response performance of the overall storage apparatus. When a storage controller of a storage apparatus receives a first read command that designates a plurality of storage areas in the logical volume as a read destination, the storage controller identifies the storage media and address that are actually storing the data written into the storage area, creates, for each of the storage media, a second read command that designates a part or all of each of the identified addresses in the identified storage media as a read destination and sends each of the created second read commands to the corresponding storage media, and transfers, to the host computer, the data that was read from each of the addresses designated in the second read command and sent from each of the storage media that sent the second read command.

### TECHNICAL FIELD

The present invention relates to a storage device and a data input/output method, and in particular can be suitably applied to a storage apparatus that is compatible with a Scatter-Gather command.

### BACKGROUND ART

The Scatter-Gather I/O command is a SCSI (Small Computer System Interface) command that is undergoing standardization activities, and includes, as I/O (Input/Output) commands, a Read Gather command as one type of read command and a Write Scatter command as one type of write command.

The Read Gather command and the Write Scatter command are sent, together with a parameter list, to the destination. The parameter list is, with regard to read/write-target data stored in each of a plurality of non-continuous storage areas, a list of initial addresses of the storage areas where such data are stored, or should be stored, and the data length of such data.

And, for example, of the Read Gather command and the Write Scatter command, a storage apparatus that received the Read Gather command reads, from the respective storage areas, each of the data having the data length designated in the parameter list, and consolidates all of the read data and sends the consolidated data to the source of the Read Gather command in a single data transfer.

As a result of using this kind of Scatter-Gather command, since read/write requests to a plurality of non-continuous storage areas can be sent with a single command, the processing load of the storage apparatus can be reduced in comparison to a case of sending read commands and write commands to the storage apparatus for each of the individual storage areas.

### CITATION LIST

### Patent Literature

### [PTL 1]

### International Publication No. 2010/131373

### SUMMARY OF INVENTION

### Technical Problem

Meanwhile, a storage controller of the storage apparatus that received the Read Gather command foremost searches for each data designated in the parameter list from the cache memory, and, by issuing a read command to the corresponding storage media regarding the cache-miss data, reads the data from that storage media. The storage controller performs this kind of reading of data from the storage media for each cache-miss data.

Thus, on the storage apparatus side that received the Read Gather command, the processing load of the read processing of data from the storage media, which is performed a plurality of times by the storage controller, becomes a bottleneck, and, even if a high-performance storage media is used as the storage media, there is a problem in that a sufficient response performance cannot not be attained as the response performance of the overall storage apparatus.

The present invention was devised in view of the foregoing points, and an object of this invention is to propose a storage apparatus and a data input/output method capable of improving the response performance of the overall storage apparatus.

### Solution to Problem

In order to achieve the foregoing object, the present invention provides, in a storage apparatus, a plurality of storage media to be connected and a storage controller that controls input/output of data to and from the storage media. The storage controller provides a logical volume to a host computer, and, upon receiving a first read command that is sent from the host computer and which designates a plurality of storage areas in the logical volume as a read destination, identifies the storage media that is actually storing the data written into the storage area and an address in the storage media for each of the storage areas in the logical volume that was designated as the read destination, and creates, for each of the storage media, a second read command that designates a part or all of each of the identified addresses in the identified storage media as a read destination, and sends each of the created second read commands to the corresponding storage media. Each of the storage media that received the second read command reads data from each of the addresses designated in the received second read command and sends the read data to the storage controller. The storage controller transfers, to the host computer, the data that was read from each of the addresses designated in the second read command and sent from each of the storage media that sent the second read command.

According to the foregoing storage apparatus, the storage controller can read data from a plurality of storage areas in the storage media by issuing a single command.

### Advantageous Effects of Invention

According to the present invention, the processing load of the storage controller related to the read processing can be reduced, and the response performance of the overall storage apparatus can be improved.

### BRIEF DESCRIPTION OF DRAWINGS

FIG. 1 is a sequence diagram explaining the flow of the read processing according to the present invention.

FIG. 2 is a sequence diagram explaining the flow of the write processing according to the present invention.

FIG. 3 is a block diagram showing the schematic configuration of the computer system according to the first embodiment.

FIG. 4 is a conceptual diagram explaining the various types of information and various programs stored in the local memory area of the memory of the first embodiment.

FIG. 5 is a conceptual diagram showing the configuration of the cache management information.

FIG. 6 is a conceptual diagram showing the configuration of the map information according to the first embodiment.

FIG. 7 is a conceptual diagram showing the command format of the Scatter-Gather command.

FIG. 8 is a conceptual diagram showing the format of the parameter list.

FIG. 9 is a conceptual diagram showing the configuration of the LBA range descriptor.

FIG. 10 is a conceptual diagram showing the configuration of the Read Gather parameter data.

FIG. 11 is a flowchart showing the processing routine of the read processing according to the first embodiment.

FIG. 12 is a flowchart showing the processing routine of the media and address identification processing according to the first embodiment.

FIG. 13 is a flowchart showing the processing routine of the write processing according to the first embodiment.

FIG. 14 is a flowchart showing the processing routine of the destaging processing according to the first embodiment.

FIG. 15 is a flowchart showing the processing routine of the media address detection processing according to the first embodiment.

FIG. 16 is a block diagram showing the schematic configuration of the computer system according to the second to fourth embodiments.

FIG. 17 is a conceptual diagram explaining the virtualization function.

FIG. 18 is a conceptual diagram explaining the various types of information and various programs stored in the local memory area of the memory of the second embodiment.

FIG. 19 is a conceptual diagram showing the configuration of the map information according to the second to fourth embodiments.

FIG. 20 is a flowchart showing the processing routine of the media and address identification processing according to the second to fourth embodiments.

FIG. 21 is a flowchart showing the processing routine of the media address detection processing according to the second to fourth embodiments.

FIG. 22 is a conceptual diagram explaining the various types of information and various programs stored in the local memory area of the memory of the third and fourth embodiments.

FIG. 23 is a flowchart showing the processing routine of the first data relocation processing.

FIG. 24 is a flowchart showing the processing routine of the second data relocation processing.

### DESCRIPTION OF EMBODIMENTS

An embodiment of the present invention is now explained in detail with reference to the drawings.

### (1) First embodiment

### (1-1) Outline of Computer System According to this Embodiment

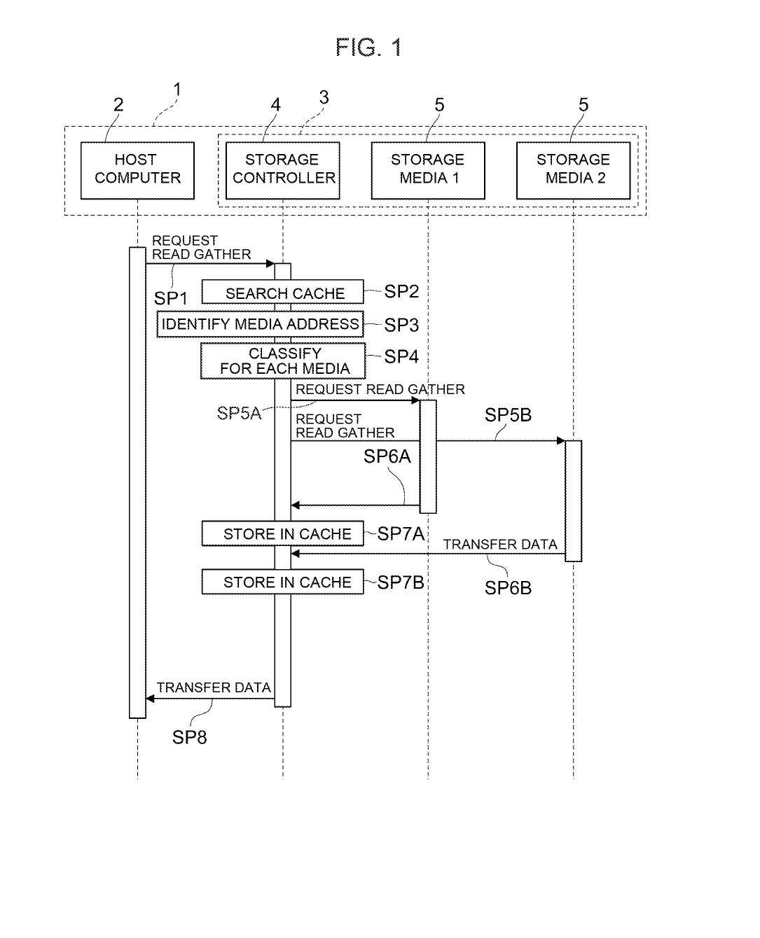

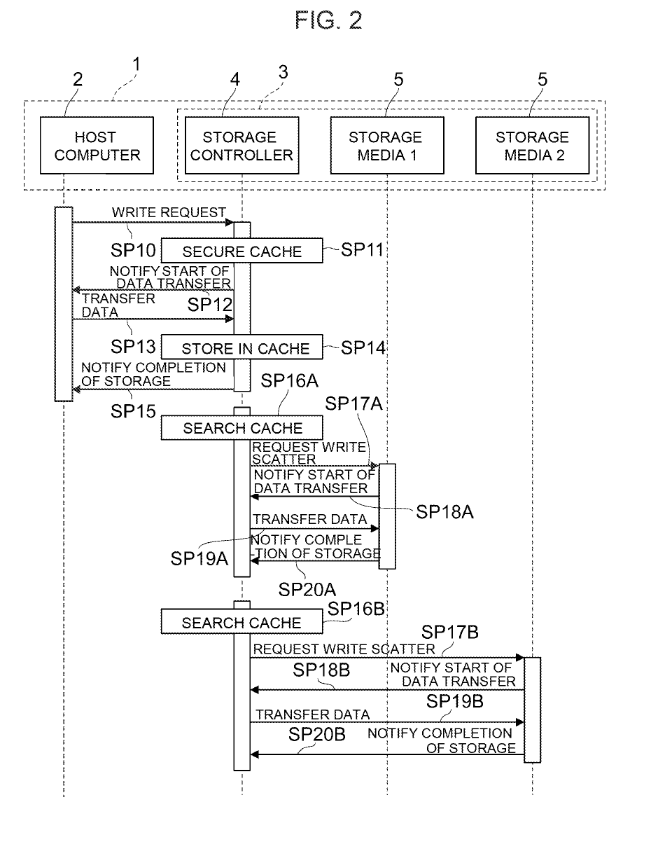

FIG. 1 and FIG. 2 show the outline of the flow of the read processing (FIG. 1), and the flow of the write processing and the destaging processing (FIG. 2) that are executed in a computer system 1 according to the first embodiment. The computer system 1 is unique in that, during the staging of reading data from the storage media 5 into the cache area of the storage controller 4 and during the destaging of writing the data stored in the cache area into the corresponding storage media 5 in the storage apparatus 3, the storage controller 4 uses the Scatter-Gather command and collectively reads/writes, from and to the storage media 5, the data that are stored, or should be stored, by being distributed in a plurality of non-continuous storage areas in the storage media 5.

Note that, while FIG. 1 and FIG. 2 show an example where the storage apparatus 3 comprises the two storage media 5 of “media 1” and “media 2”, the processing flow is the same when there is only one storage media 5 or when there are three or more storage media 5. Moreover, while FIG. 1 and FIG. 2 show an example of reading/writing data from the host computer 2 into a storage area that is provided by one storage media 5, the processing flow is the same when configuring a RAID (Redundant Arrays of Independent Disks) group from a plurality of storage media 5, and reading/writing data from the host computer 2 from and to a storage area provided by that RAID group.

The flow of the read processing in the computer system 1 is foremost explained with reference to FIG. 1. When the host computer 2 is to collectively read data from a plurality of non-continuous storage areas in the storage apparatus 3, the host computer 2 sends, to the storage apparatus 3, a parameter list that designates each of the storage areas as a read destination together with a Read Gather command (SP1).

The storage controller 4 of the storage apparatus 3 that received the Read Gather command and the parameter list searches for each data designated in the parameter list from the cache area (SP2), and, with regard to data that is not stored in the cache area (data that did not result in a cache hit), identifies the storage media 5 storing that data and the address in that storage media 5, respectively (SP3).

Moreover, the storage controller 4 classifies each data for which the storage media 5 and the address in that storage media 5 were identified for each storage media 5 storing that data (SP4). Subsequently, the storage controller 4 generates a Read Gather command and a parameter list for each storage media 5 based on the classification result, and respectively sends the generated Read Gather command and parameter list to the corresponding storage media 5 (SP5A, SP5B).

Each storage media 5 that received the Read Gather command and the parameter list reads data from each storage area designated in the parameter list, and collectively transfers each of the read data to the storage controller 4 (SP6A, SP6B).

When the storage controller 4 receives the read-target data that was transferred from the storage media 5, the storage controller 4 sequentially stores that data in the cache area (SP7A, SP7B). Moreover, when the storage controller 4 finishes receiving all data from all storage media 5, the storage controller 4 collectively sends, to the host computer 2 as the source of the foregoing Read Gather command, the read-target data (data that resulted in a cache hit) that was detected in the cache area in step SP2, and the read-target data that was read from each storage media 5 as described above (SP8). When the data transfer from the storage controller 4 to the host computer 2 is completed, this read processing is ended.

The flow of the write processing and the destaging processing in the computer system 1 is now explained with reference to FIG. 2. When the host computer 2 writes data in the storage apparatus 3, the host computer 2 sends a write command to the storage apparatus 3 (SP10). Note that the write command to be sent from the host computer 2 to the storage apparatus 3 in this case may be either a Write Scatter command or a standard write command.

The storage controller 4 of the storage apparatus 3 that received the write command secures the storage area of the required capacity in the cache memory (SP11), and thereafter sends a notice requesting the start of data transfer (this is hereinafter referred to as the “data transfer start notice”) to the host computer 2 (SP12). Consequently, the host computer 2 that received the data transfer start notice starts the data transfer, and sequentially transfers the write-target data to the storage apparatus 3 (SP13).

When the storage controller 4 receives the write-target data, the storage controller 4 sequentially stores the received write-target data in the cache area (SP14). When the storage controller 4 eventually receives all write-target data and finishes storing all such data in the cache area, the storage controller 4 sends a notice to the effect that the storage of data is complete (this is hereinafter referred to as the “storage completion notice”) to the host computer 2 (SP15). The write-target data transfer processing between the host computer 2 and the storage apparatus 3 is thereby completed.

Meanwhile, the storage controller 4 periodically executes the destaging processing of writing data, which has not been destaged to the storage media 5 among the data stored in the cache area, into the storage area in the storage media 5 that is designated in the write command regarding that data (SP16A to SP20A, SP16B to SP20B).

In the destaging processing, the storage controller 4 selects one storage media 5 as the target, and searches for data among the data stored in the cache area which is data to be written into that storage media 5 but has not yet been written into that storage media 5 (SP16A).

Subsequently, the storage controller 4 generates a Write Scatter command and a parameter list that designate the address for storing the data and the data length of that data with regard to all data that were detected in the foregoing search, and sends the generated Write Scatter command and parameter list to the storage media 5 that was selected in step SP16A (SP17A).

Moreover, when the storage media 5 that received the foregoing Write Scatter command and parameter list completes its preparation for receiving data, that storage media 5 sends a data transfer start notice to the storage controller 4 (SP18A). Consequently, the storage controller 4 that received the data transfer start notice starts the data transfer, sequentially reads, from the cache area, all data for which the address of the storage destination thereof was designated in the parameter list, and collectively transfers the read data to the storage media 5 (SP19A).

When the storage media 5 receives the foregoing data, the storage media 5 stores each of the received data at the address that is designated in the parameter list. When the storage media 5 eventually receives all data that are designated in the parameter list and finishes storing all such data at the address designated in the parameter list, the storage media 5 sends a storage completion notice to the storage controller 4 (SP20A). The destaging processing of destaging data to the storage media 5 is thereby completed.

The storage controller 4 performs the same processing as step SP16A to step SP20A with regard to the other storage media 5, in order for each storage media 5 or in parallel for all storage media 5 (SP16B to SP20B).

As described above, according to the computer system 1 of this embodiment, since the Scatter-Gather command (Read Gather command and Write Scatter command), for which technical development is being actively pursued, is also used in the data transfer between the storage controller 4 and the storage media 5 in the storage apparatus 3, it is possible to further reduce the overhead during the data transfer between the storage controller 4 and the storage media 5. Consequently, it is possible to reduce the processing load of the storage controller 4, and further improve the response performance of the overall storage apparatus 3.

The computer system 1 according to this embodiment with the foregoing functions is now explained in detail.

### (1-2) Configuration of Computer System According to this Embodiment

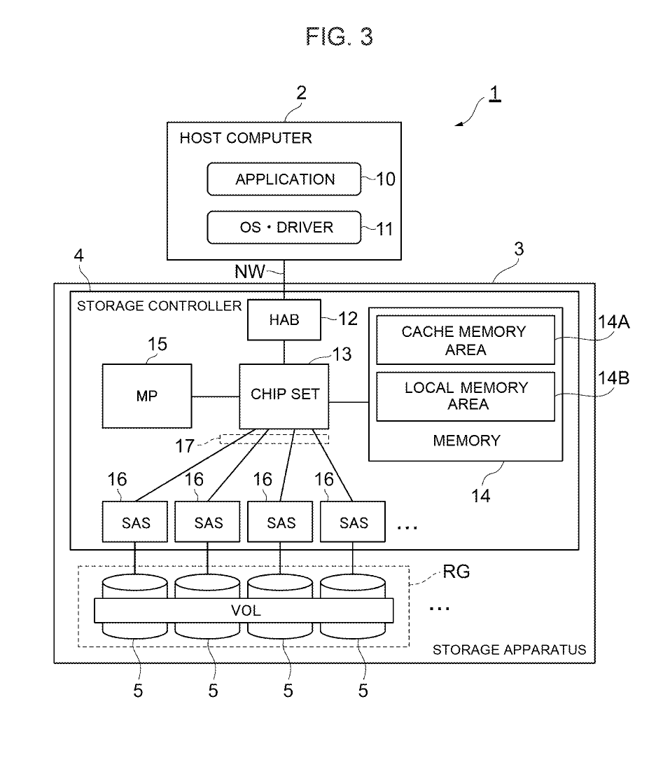

FIG. 3 shows the computer system 1 according to this embodiment. In this computer system 1, the host computer 2 and the storage apparatus 3 are connected via a SCSI network NW.

The host computer 2 is, for example, a computer device comprising information processing resources such as a CPU (Central Processing Unit) and a memory, and is configured from a personal computer, a workstation, a mainframe or the like. The host computer 2 is loaded with software such as an application 10 that issues a read request or a write request of data to the storage apparatus 3, and an OS (Operating System) driver 11 that converts the read request or write request issued from the application 10 into an I/O command (read command, write command, Read Gather command, Write Scatter command or the like) that is compliant with the SCSI standard, and sends the I/O command to the storage apparatus 3.

The storage apparatus 3 is configured by comprising one or more storage media 5, and a storage controller 4 that controls the input/output (writing/reading) of data to and from the storage media 5.

The storage media 5 is configured from a hard disk device configured from SAS (Serial Attached SCSI) disks or SATA (Serial AT Attachment) disks, or a semiconductor memory configured from a flash memory or an SSD (Solid State Drive). A plurality of storage media 5 of the same type are managed as one RAID group RG, and one or more logical volumes (this is hereinafter referred to as the “logical volume(s)”) VOL are set on a physical storage area provided by the respective storage media 5 configuring the one RAID group RG. Data from the host computer 2 is stored in this logical volume VOL in units of a block of a predetermined size (this is hereinafter referred to as the “logical block”).

A unique identifier (this is hereinafter referred to as the “volume number”) is assigned to the logical volume VOL. In this embodiment, the input/output of data to and from the logical volume VOL are performed by designating the initial LBA (this is hereinafter referred to as the “initial LBA”) in the logical volume VOL from or to which data is read/written, and the data length of the data to be read/written.

Note that, in this embodiment, a storage media that is compliant with the foregoing Scatter-Gather command is adopted as the storage media 5. Accordingly, when the storage media 5 receives a Read Gather command and a parameter list from the storage controller 4, the storage media 5 reads data from the respective storage areas that are designated in that parameter list and transfers the read data to the storage controller 4. Meanwhile, when the storage media 5 receives a Write Scatter command, a parameter list and write-target data from the storage controller 4, the storage media 5 stores the corresponding write-target data in the respective storage areas that are designated in that parameter list.

The storage controller 4 is configured by comprising, for example, a host bus adapter (HBA: Host Bus Adapter) 12, a chip set 13, a memory 14, a microprocessor (MP: Microprocessor) 15 and a plurality of disk adapters 16.

The host bus adapter 12 is an interface with a function of performing protocol control upon communicating with the host computer 2, and sends and receives various commands and data to and from the host computer 2. The chip set 13 has a function of controlling the data transfer between the respective elements in the storage controller 4. Data transfer among the host bus adapter 12, the memory 14, the microprocessor 15 and the disk adapters 16 is performed via the chip set 13.

The memory 14 is configured, for example, from a semiconductor memory such as a dynamic random access memory (DRAM), and the storage area is used by being dividing into a cache memory area 14A, and a local memory area 14B. In addition, data to be input/output to and from the storage media 5 and commands from the host computer 2 are temporarily stored in the cache memory area 14A, and various programs and various types of data, which are read from a specific storage media 5 at the startup of the storage apparatus 3, are stored in the local memory area 14B.

The microprocessor 15 has a function of governing the operational control of the overall storage controller 4. The microprocessor 15 executes necessary arithmetic processing and control processing based on the commands from the host computer 2 which are stored in the cache memory area 14A of the memory 14, and the control programs and various types of data which are stored in the local memory area 14B of the memory 14.

The disk adapter 16 is an interface that controls the communication with the respective storage media 5, and is connected to the respective storage media 5 via a communication path 17 such as a SCSI cable or a SCSI network. The disk adapter 16 controls the communication with the storage media 5 according to a communication protocol that is compliant with the SAS standard.

### (1-3) Configuration of Various Programs and Various Types of Information

As described above, the computer system 1 is unique in that that storage apparatus 3 is equipped with a staging/destaging function of using the Scatter-Gather command to collectively read/write data from and to the storage media 5 upon staging data stored in the storage media 5 to the cache memory area 14A of the memory 14 in the storage controller 4, and upon destaging the data from the cache memory area 14A to the storage media 5 in the storage apparatus 3.

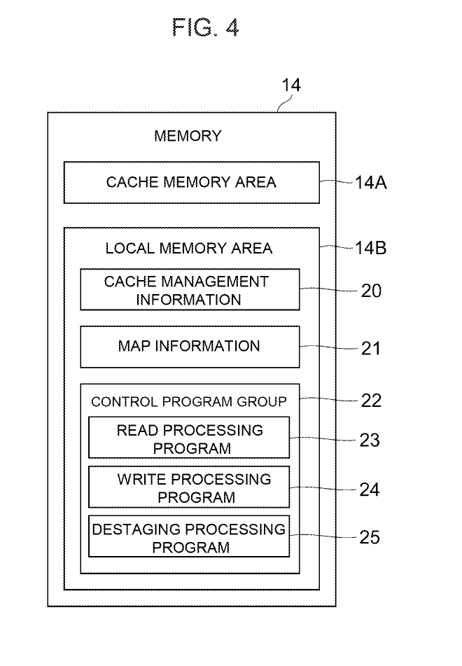

As means for realizing this kind of staging/destaging function, the local memory area 14B of the memory 14 in the storage apparatus 3 stores, as shown in FIG. 4, cache management information 20, map information 21 and a control program group 22.

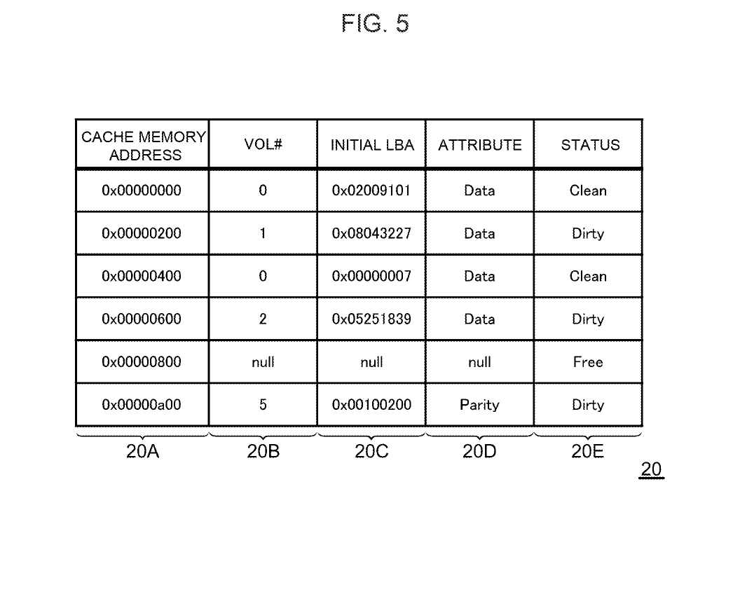

Among the above, the cache management information 20 is information that is used for managing the data that is temporarily stored in the cache memory area 14A of the memory 14, and, as shown in FIG. 5, has a table-like data configuration comprising a cache memory address column 20A, a volume number column 20B, an initial LBA column 20C, an attribute column 20D and a status column 20E.

The cache memory address column 20A stores each of the addresses in the cache memory area 14A of the memory 14 (this is hereinafter referred to as the “cache memory address”). Moreover, the volume number column 20B stores the volume number of the logical volume VOL into which the data that was stored at the corresponding cache memory address was written, and the initial LBA column 20C stores the initial LBA of the storage area in that logical volume VOL into which the foregoing data was written.

The attribute column 20D stores the attribute of the data stored in the corresponding cache memory address. As the attribute of data, there are the user data (“Data”) that was written by the host computer 2, and the parity data (“Parity”) that was generated based on that user data.

The status column 20E stores the status of the data stored in the corresponding cache memory address. As the status of data, there are clean (“Clean”) which represents that the data is destaged data (this is hereinafter referred to as the “clean data”), and (“Dirty”) which represents that the data has not been destaged (this is hereinafter referred to as the “dirty data”).

Accordingly, the example of FIG. 5 shows that, for example, the data stored in the cache memory address of “0x00000000” in the memory 14 is the user data (“Data”) that is stored in the storage area, which has an initial LBA of “0x02009101”, in the logical volume VOL with a volume number of “0”, and has previously been destaged (“Clean”).

Note that, in the cache management information 20, “Null”, which represents that there is no information with regard to the cache memory address that does not store data of the memory 14, is stored in the volume number column 20B, the initial address column 20C and the attribute column 20D, respectively, and the information of “Free” is stored in the status column 20E.

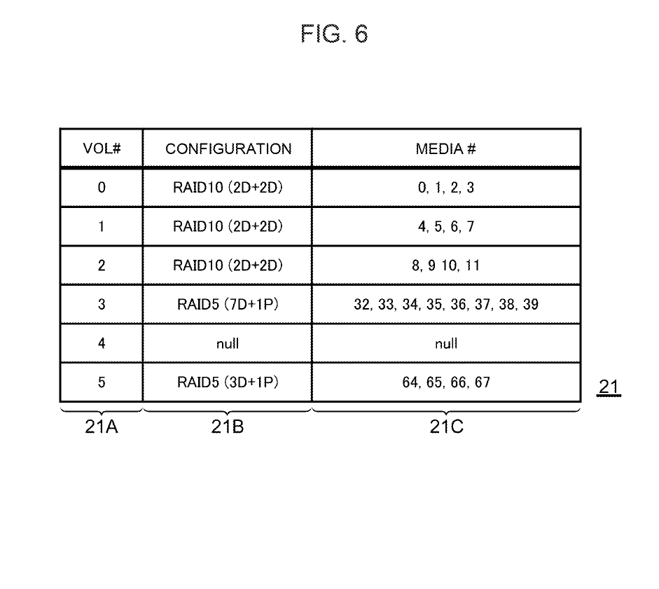

The map information 21 is information that is used for managing the configuration of the respective logical volumes VOL, and, as shown in FIG. 6, has a table-like data configuration comprising a volume number column 21A, a configuration column 21B and a media number column 21C.

The volume number column 21A stores the volume number of the respective logical volumes VOL which are being provided by the storage controller 4 to the host computer 2, and the configuration column 21B stores information indicating the RAID configuration of the RAID group RG that provides the corresponding logical volumes VOL. Moreover, the media number column 21C stores the identification number (storage media number) of all storage media 5 that configure the corresponding RAID group RG.

Accordingly, the example of FIG. 6 shows that, for example, the logical volume VOL with the volume number of “0” is a storage area that is provided by a RAID group RG having a RAID configuration of “RAID10”, which is configured from four storage media 5 each assigned a storage media number of “0”, “1”, “2” and “3”, respectively. Moreover, FIG. 6 also shows that the RAID group RG has a configuration of storing the data by distributing that data in two storage media 5, and mirroring such data (“2D+2D”).

Note that, in the map information 21, “null”, which implies that there is no information in the configuration column 21B and the media number column 21C, is stored in an undefined entry (line) of the volume number of the logical volume VOL.

Meanwhile, the control program group 22 is configured by comprising, as shown in FIG. 4, a read processing program 23, a write processing program 24 and a destaging processing program 25.

The read processing program 23 is a program that is launched when a read command including a Read Gather command is sent from the host computer 2, and the write processing program 24 is a program that is launched when a write command including a Write Scatter command is sent from the host computer 2.

Moreover, the destaging processing program 25 is a program that is launched upon destaging dirty data, which is stored in the cache memory area 14A of the memory 14, to the corresponding storage media 5.

The detailed functions of the read processing program 23, the write processing program 24 and the destaging processing program 25 will be described later.

### (1-4) Configuration of Scatter-Gather Command and Other Commands

The command format of the Scatter-Gather command (Read Gather command and Write Scatter command) that is exchanged between the host computer 2 and the storage apparatus 3, and between the storage controller 4 and the storage media 5 of the storage apparatus 3, is now explained.

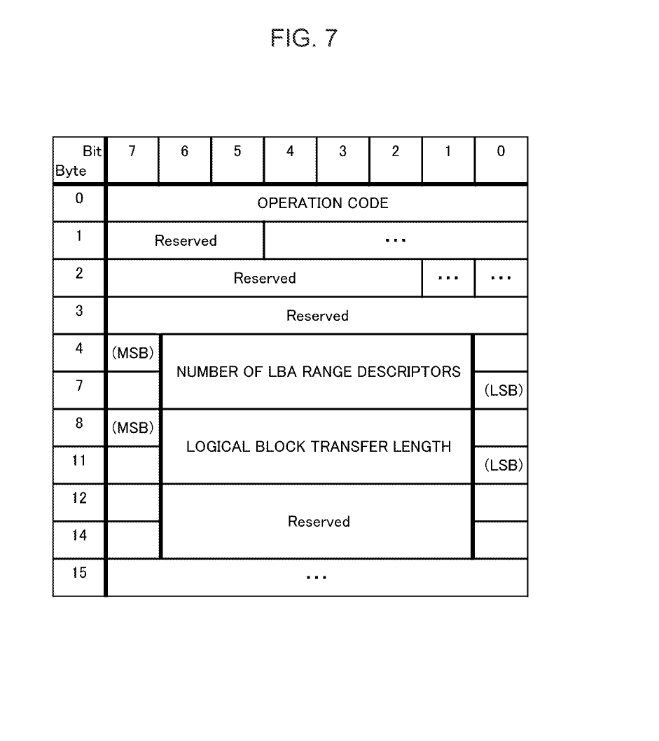

FIG. 7 shows the command format of the Scatter-Gather command. As shown in FIG. 7, the 0th byte of the Scatter-Gather command stores the operation code (“OPERATION CODE”) of the Scatter-Gather command. The operation code that is used here is a code that indicates whether the Scatter-Gather command is a Read Gather command or a Write Scatter command.

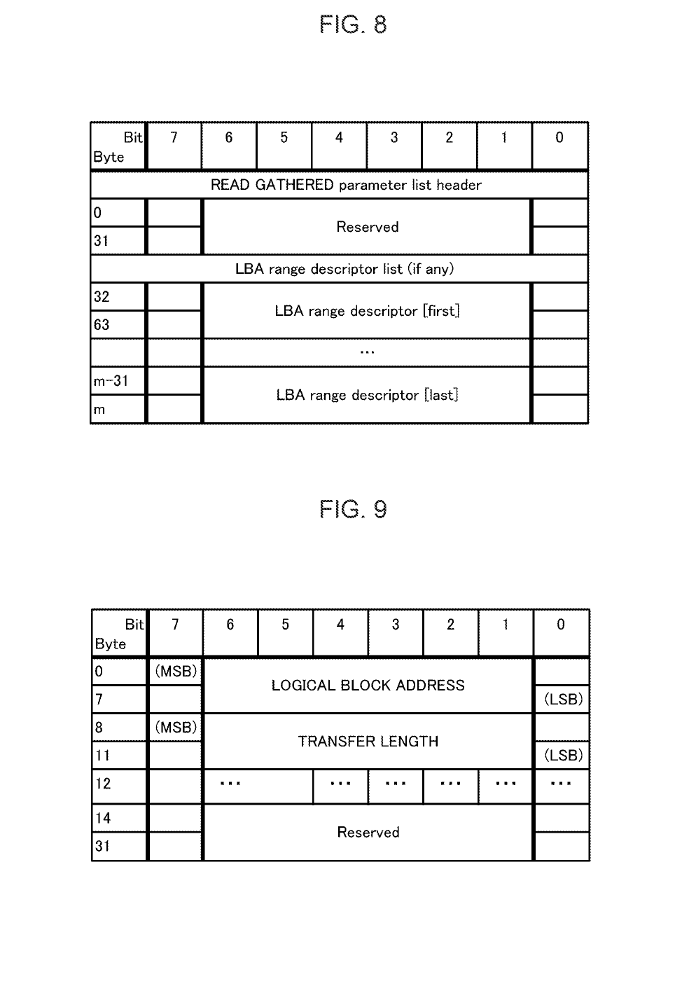

Moreover, the 4th to 7th bytes of the Scatter-Gather command store the number of LBA range descriptors (“LBA range descriptors”) described later which are stored in the parameter list (FIG. 8) to be sent to the command destination together with the Scatter-Gather command, and the 8th to 11th bytes of the Scatter-Gather command store the total value of the data lengths of the respective data to be read/written based on the Scatter-Gather command.

Note that the designation of the read/write-target logical volume is performed by designating the logical volume number (LUN: Logical Unit Number) in the transport layer of the network. Specifically, when a fibre channel protocol has been adopted as the communication protocol in the SCSI network NW (FIG. 1), the LUN of the target logical volume is stored in the LUN field in the fibre channel protocol, and when an iSCSI protocol has been adopted as the communication protocol in the SCSI network NW, it is stored in the BHS (Basic Header Segment) (refer to Byte 8 of “10.2.1” of “http://tools.ietf.org/html/rfc3720#page-116”).

FIG. 8 shows the format of the parameter list that is sent from the command source to the command destination together with the foregoing Scatter-Gather command (FIG. 7). As shown in FIG. 8, the 32nd byte onward of the parameter list store the LBA range descriptors (“LBA range descriptors”) each having a data size of 32 bytes in the same quantity as the number of data to be read/written based on that Scatter-Gather command.

FIG. 9 shows the specific contents of the LBA range descriptors (“LBA range descriptors”) stored in the parameter list (FIG. 8). The LBA range descriptor is a descriptor for designating, upon reading/writing data from and into a plurality of non-continuous storage areas in the logical volume VOL or in the storage media 5 based on the Scatter-Gather command, those storage areas and the data length of all data to be read/written from and into those storage areas, and is created for each storage area from and into which data is to be read/written. As shown in FIG. 9, the 0th to 7th bytes of the LBA range descriptor store the initial LBA (“LOGICAL BLOCK ADDRESS”) of the storage area from and into which data is to be read/written among the storage areas in the logical volume VOL or in the storage media 5, and the 8th to 11th bytes store the data length (“TRANSFER LENGTH”) of the data to be read/written from and into that storage area.

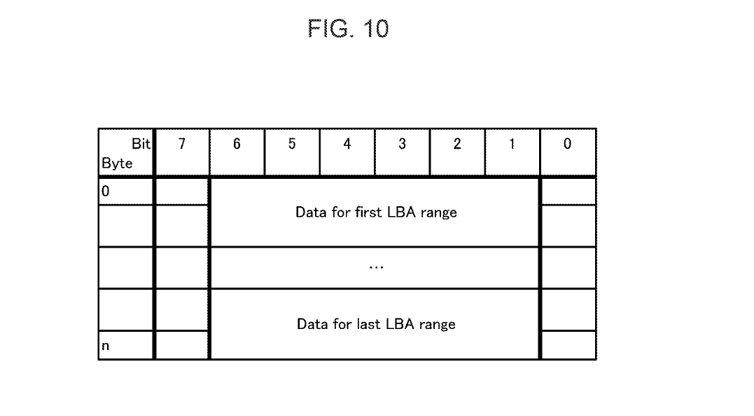

FIG. 10 shows the data format of the parameter data that is sent from the storage apparatus 3 or the storage media 5 that received the Read Gather command as the Scatter-Gather command to the host computer 2 or the storage controller 4 as the source of that Read Gather command. As shown in FIG. 10, the storage apparatus 3 or the storage media 5 that received the Read Gather command rearranges the data read from each of the storage areas designated in the Read Gather command in the corresponding logical volume VOL or storage media 5 in the same order as the corresponding LBA range descriptors (“LBA range descriptors”) in that Read Gather command, and sends this to the host computer 2 or the storage controller 4 as the source of the Read Gather command.

### (1-5) Various Types of Processing Related to I/O

The specific processing contents of the various types of processing that are executed in relation to the reading/writing of data in the computer system 1 are now explained. While the processing entity of the various types of processing is explained as a “program” in the ensuing explanation, it goes without saying that, in effect, the microprocessor 15 of the storage apparatus 3 will execute the processing based on that program.

### (1-5-1) Read Processing

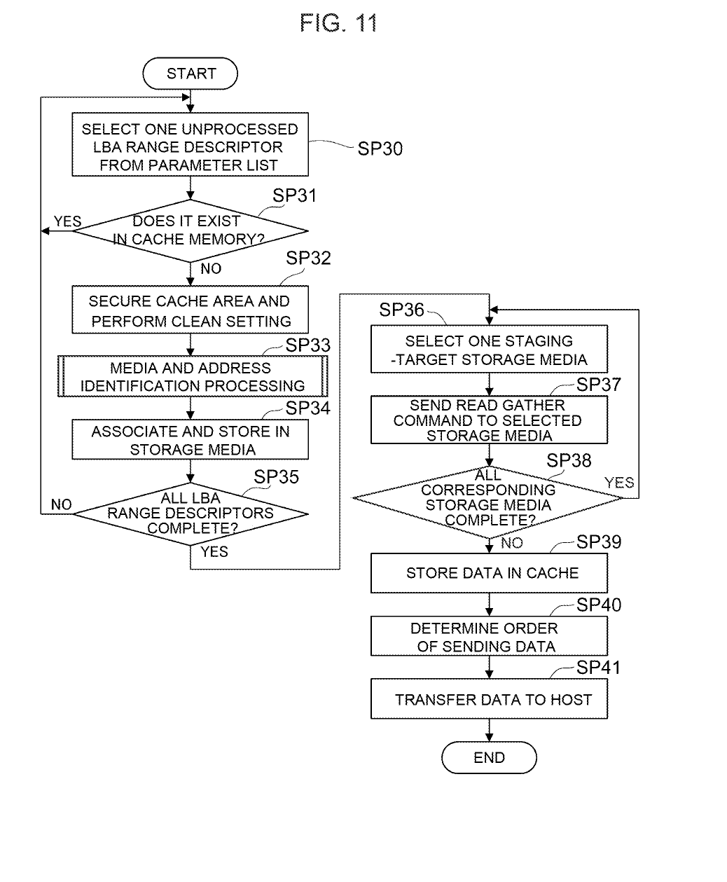

FIG. 11 shows the processing routine of the read processing to be executed by the read processing program 23 (FIG. 4) of the storage apparatus 3 that received the Read Gather command (refer to FIG. 6) and the parameter list (refer to FIG. 7) from the host computer 2.

The read processing program 23 starts the read processing when the storage controller 4 receives the Read Gather command and the parameter list from the host computer 2, and foremost selects one LBA range descriptor among the unprocessed LBA range descriptors that are registered in the received parameter list (SP30).

Subsequently, the read processing program 23 refers to the cache management information 20 (FIG. 5), and determines whether the data, which was written into the storage area in the logical volume VOL having, as its initial LBA, the LBA that is designated in the LBA range descriptor selected in step SP30 (this is hereinafter referred to as the “selected LBA range descriptor”), still exists in the cache memory area 14A of the memory 14 (SP31).

When the read processing program 23 obtains a positive result in this determination, the read processing program 23 returns to step SP30. Meanwhile, when the read processing program 23 obtains a negative result in the determination of step SP30, the read processing program 23 secures, in the cache memory area 14A of the memory 14, a storage area of the same capacity as the data length that is designated in the selected LBA range descriptor, and stores “Clean” in the status column 20E (FIG. 5) of the entry corresponding to the storage area that was secured in the cache memory area 14A among the entries (lines) of the cache management information 20 (SP32).

Subsequently, the read processing program 23 executes the media and address identification processing of identifying the storage media 5 that is actually storing the data written into the storage area in the logical volume VOL that was designated in the selected LBA range descriptor (this data is hereinafter referred to as the “data registered in the LBA range descriptor”), and the address in that storage media 5 where the data is stored (SP33).

Moreover, the read processing program 23 associates the selected LBA range descriptor and the storage media 5 that is actually storing the data designated in the selected LBA range descriptor based on the identification result of step SP33 (SP34).

The read processing program 23 thereafter determines whether the processing of step SP30 to step SP34 has been executed for all LBA range descriptors that are registered in the received parameter list (SP35).

When the read processing program 23 obtains a negative result in this determination, the read processing program 23 returns to step SP30, and thereafter repeats the processing of step SP30 to step SP35 while sequentially switching the LBA range descriptor that is selected in step SP30 to another unprocessed LBA range descriptor.

When the read processing program 23 obtains a positive result in step SP35 as a result of completing the processing of step SP30 to step SP34 for all LBA range descriptors that are registered in the received parameter list, the read processing program 23 selects one storage media 5 among the storage media 5 that has been associated with at least one LBA range descriptor based on the foregoing repetition processing of step SP30 to step SP35 (SP36).

Subsequently, the read processing program 23 creates, based on the repetition processing of step SP30 to step SP35, a Read Gather command and a parameter list for collectively reading, from the selected storage media 5, each data registered in the LBA range descriptor associated with the storage media (this is hereinafter referred to as the “selected storage media”) 5 that was selected in step SP36. Subsequently, the read processing program 23 sends the created Read Gather command and parameter list to the selected storage media 5 (SP37).

Specifically, the read processing program 23 replaces the initial LBA designated in the LBA range descriptor with the address in the selected storage media 5 identified in step SP33 with regard to the respective LBA range descriptors that were associated with the selected storage media 5 based on the repetition processing of step SP30 to step SP35. Subsequently, the read processing program 23 creates a parameter list registering all LBA range descriptors in which the initial LBA was replaced with the address in the selected storage media 5 as described above.

Moreover, the read processing program 23 creates a Read Gather command which stores the number of LBA range descriptors registered in the created parameter list in the 4th to 7th bytes of FIG. 7, and stores the total data size of the respective data lengths, which were designated in the respective LBA range descriptors registered in the parameter list, in the 8th to 11th bytes of FIG. 7. Subsequently, the read processing program 23 sends the created Read Gather command and parameter list to the selected storage media 5.

Subsequently, the read processing program 23 determines whether the processing of step SP36 and step SP37 has been executed for all storage media 5 that are associated with at least one LBA range descriptor based on the foregoing repetition processing of step SP30 to step SP35 (SP38).

When the read processing program 23 obtains a negative result in this determination, the read processing program 23 returns to step SP36, and thereafter repeats the processing of step SP36 to step SP38 while sequentially switching the storage media 5 that was selected in step SP36 to another unprocessed storage media.

When the read processing program 23 obtains a positive result in step SP38 as a result of sending the Read Gather command and the parameter list to all storage media 5 that are associated with at least one LBA range descriptor based on the foregoing repetition processing of step SP36 to step SP38, the read processing program 23 sequentially stores the read-target data that is transferred from the respective storage media 5, to which the Read Gather command and the parameter list were sent, in the storage area that was secured in the cache memory area 14A of the memory 14 in step SP32 (SP39).

In addition, when the read processing program 23 finishes transferring all read-target data from all storage media 5 to which the Read Gather command and the parameter list were sent, and additionally finishes storing all such data in the cache memory area 14A of the memory 14, the read processing program 23 transfers all read-target data to the host computer 2 as the source of the Read Gather command that triggered the execution of this read processing (SP41).

Specifically, the read processing program 23 sequentially reads, from the cache memory area 14A of the memory 14, the read-target data corresponding to each of the LBA range descriptors registered in the parameter list that was sent together with the Read Gather command in the order of the corresponding LBA range descriptors in that parameter list, and sequentially sends the read data to the host computer 2 as the source of the Read Gather command according to the data format shown in FIG. 10.

When the read processing program 23 finishes sending all data designated in the Read Gather command and the parameter list to the host computer 2 as the source of the Read Gather command and the parameter list, the read processing program 23 ends this read processing.

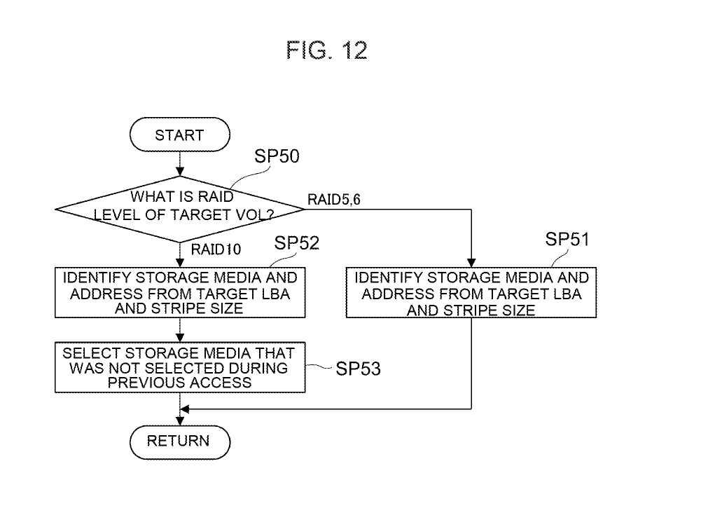

The specific processing contents of the processing (this is hereinafter referred to as the “media and address identification processing”) that is executed by the read processing program 23 in step SP33 of the read processing described above are shown in FIG. 12. In the ensuing explanation, let it be assumed that the RAID level of the RAID group RG is set to one among “RAID10”, “RAID5” and “RAID6”.

The read processing program 23 starts the media and address identification processing upon proceeding to step SP33 of the read processing, and foremost refers to the map information 21 and determines the RAID level of the logical volume VOL into which the selected data registered in the LBA range descriptor was written (SP50).

When the read processing program 23 recognizes that the RAID level of the logical volume VOL is RAID5 or RAID6 in this determination, the read processing program 23 identifies the storage media 5 that is actually storing the selected data registered in the LBA range descriptor and the address in that storage media 5 based on the LBA that is designated in the selected LBA range descriptor in the logical volume VOL and the stripe size that is defined with regard to that logical volume VOL (SP51). The read processing program 23 thereafter ends this media and address identification processing, and proceeds to step SP34 of the read processing.

Meanwhile, when the read processing program 23 recognizes that the RAID level of the logical volume VOL is RAID10 in the determination of step SP50, the read processing program 23 identifies the storage media 5 that is actually storing the selected data registered in the LBA range descriptor and the address in that storage media 5 based on the LBA that is designated in the selected LBA range descriptor in the logical volume VOL and the stripe size that is defined with regard to that logical volume VOL (SP52).

Note that, when the RAID level of the logical volume VOL is RAID10, since the data is mirrored and stored upon being distributed in a plurality of storage media 5, in step SP52, a plurality of storage media 5 are identified as the storage media 5 that is actually storing the selected data registered in the LBA range descriptor.

Hence, the read processing program 23 determines the storage media 5 that was not selected in the previous read processing among the plurality of storage media 5 identified in step SP52 as the storage media 5 that is actually storing the selected data registered in the LBA range descriptor in order to improve the throughput performance of the read processing by reading the data in order from the plurality of storage media 5 (SP53).

The read processing program 23 thereafter ends this media and address identification processing, and proceeds to step SP34 of the read processing.

### (1-5-2) Write Processing

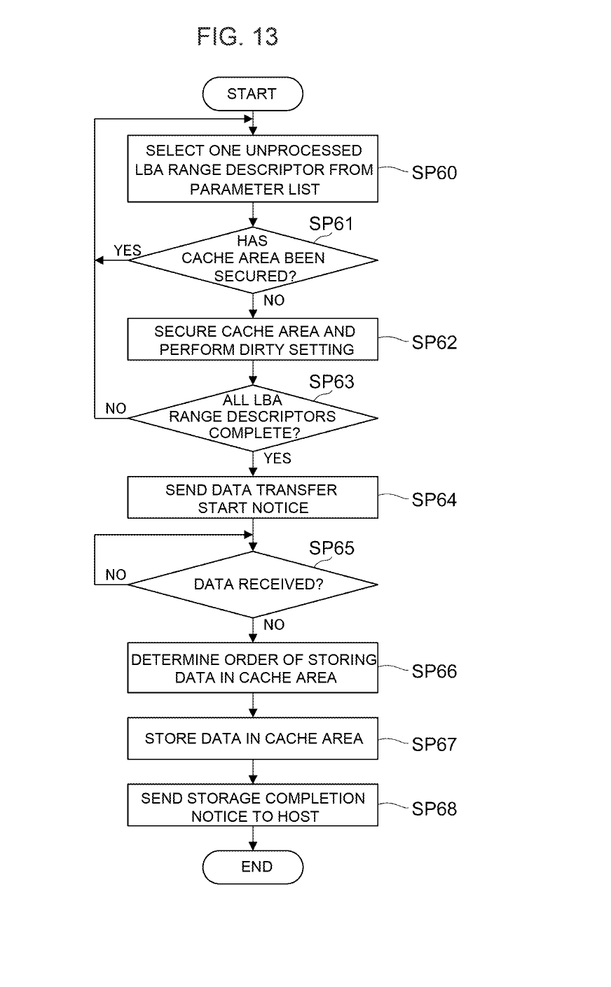

Meanwhile, FIG. 13 shows the processing routine of the write processing to be executed by the write processing program 24 (FIG. 4) of the storage apparatus 3 that received the Write Scatter command from the host computer 2.

The write processing program 24 starts the write processing when the storage controller 4 receives the Write Scatter command (refer to FIG. 7) and the parameter list (refer to FIG. 8) from the host computer 2, and foremost selects one LBA range descriptor among the unprocessed LBA range descriptors that are registered in the received parameter list (SP60).

Subsequently, the write processing program 24 refers to the cache management information 20 (FIG. 5), and determines whether a storage area for storing the data corresponding to the LBA range descriptor selected in step SP60 (this is hereinafter referred to as the “selected LBA range descriptor”) has been secured in the cache memory area 14A of the memory 14 (SP61). Note that, when the data corresponding to the selected LBA range descriptor is data to be written over the data that was previously stored in the cache memory area 14A of the memory 14, a positive result is obtained in step SP61.

When the write processing program 24 obtains a positive result in this determination, the write processing program 24 returns to step SP60. Meanwhile, when the write processing program 24 obtains a negative result in the determination of step SP61, the write processing program 24 secures a storage area of the same size as the data length of the data corresponding to the selected LBA range descriptor in the cache memory area 14A of the memory 14, and stores “Dirty” in the status column 20E (FIG. 5) of the entry corresponding to the secured storage area among the entries (lines) of the cache management information 20 (SP62).

Subsequently, the write processing program 24 determines whether the processing of step SP60 to step SP62 has been executed for all LBA range descriptors in the received parameter list (SP63).

When the write processing program 24 obtains a negative result in this determination, the write processing program 24 returns to step SP60, and thereafter repeats the processing of step SP60 to step SP63 while sequentially switching the LBA range descriptor that was selected in step SP60 to another unprocessed LBA range descriptor.

When the write processing program 24 eventually obtains a positive result in step SP63 as a result of finishing the processing of step SP60 to step SP62 for all LBA range descriptors in the received parameter list, the write processing program 24 sends the data transfer start notice explained with reference to FIG. 2 (refer to SP12 of FIG. 2) to the host computer 2 (SP64).

The write processing program 24 thereafter waits for the write-target data to be transferred from the host computer 2 (SP65), and, when the write-target data is eventually transferred from the host computer 2 (SP65: YES), determines the order of storing the write-target data in the cache memory area 14A of the memory 14 according to the registration order of the respective LBA range descriptors that are registered in the parameter list (SP66). Note that, in this embodiment, let it be assumed that the write-target data is stored in a storage area with a smaller cache memory address in the cache memory area 14A of the memory 14 as the registration order of the respective LBA range descriptors that are registered in the parameter list is earlier.

Subsequently, the write processing program 24 thereafter sequentially stores the write-target data that is transferred from the host computer 2 into the storage area that was secured in the cache memory area 14A of the memory 14 in step SP62 (SP67). When the write processing program 24 finishes storing all write-target data in the cache memory area 14A of the memory 14, the write processing program 24 sends the storage completion notice explained with reference to FIG. 2 (refer to step SP15 o FIG. 2) to the host computer 2 (SP68), and thereafter ends this write processing.

### (1-5-3) Destaging Processing

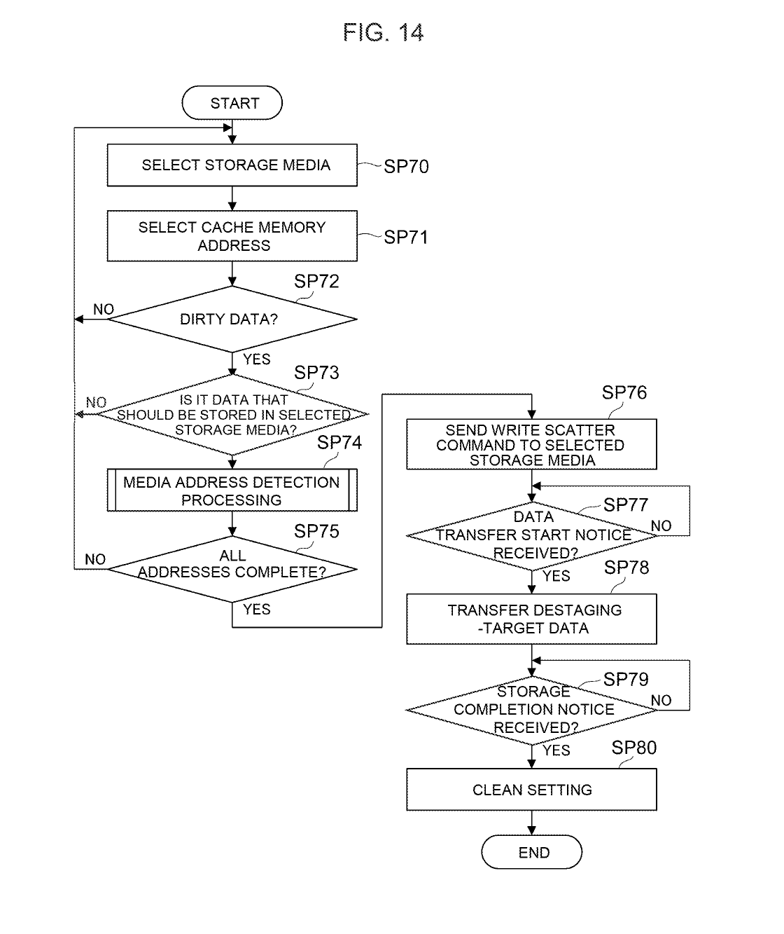

Meanwhile, FIG. 14 shows the processing routine of the destaging processing that is executed periodically by the destaging processing program 25 (FIG. 4) of the storage apparatus 3, and sequentially or in parallel for each storage media 5.

When the destaging processing program 25 starts the destaging processing, the destaging processing program 25 foremost selects one storage media 5 to which the destaging processing has not yet been performed in this cycle (SP70).

Subsequently, the destaging processing program 25 refers to the cache management information 20 (FIG. 5), and selects one cache memory address in the cache memory area 14A of the memory 14 that has not yet been processed (SP71).

Subsequently, the destaging processing program 25 refers to the cache management information 20, and determines whether the data stored in the storage area that is identified by the cache memory address, which was selected in step SP71 (this is hereinafter referred to as the “selected cache memory address”), in the cache memory area 14A of the memory 14 is dirty data (SP72).

When the destaging processing program 25 obtains a negative result in this determination, the destaging processing program 25 returns to step SP71. Meanwhile, when the destaging processing program 25 obtains a positive result in the determination of step SP72, the destaging processing program 25 refers to the cache management information 20, and determines whether the data stored in the storage area identified by the selected cache memory address in the cache memory area 14A of the memory 14 is data to be stored in the storage media 5 that was selected in step SP70 (this is hereinafter referred to as the “selected storage media 5”) (SP73).

When the destaging processing program 25 obtains a negative result in this determination, the destaging processing program 25 returns to step SP71. Meanwhile, when the destaging processing program 25 obtains a positive result in the determination of step SP73, the destaging processing program 25 executes the media address detection processing of detecting the address in the storage media 5 corresponding to the selected cache memory address (this is hereinafter referred to as the “media address”) (SP74).

The destaging processing program 25 thereafter determines whether the processing of step SP71 to step SP75 has been executed for all cache memory addresses in the cache memory area 14A of the memory 14 (SP75). When the destaging processing program 25 obtains a negative result in this determination, the destaging processing program 25 returns to step SP71, and thereafter repeats the processing of step SP71 to step SP75 while sequentially switching the cache memory address selected in step SP71 to another unprocessed cache memory address.

When the destaging processing program 25 eventually obtains a positive result in step SP75 as a result of finishing the processing of step SP71 to step SP74 for all cache memory addresses in the cache memory area 14A of the memory 14, the destaging processing program 25 sends the Write Scatter command and the parameter list to the selected storage media 5 (SP76).

Specifically, the destaging processing program 25 foremost creates an LBA range descriptor for each dirty data stored in the selected storage media 5 that was detected in the repetition processing of step SP70 to step SP75. With this LBA range descriptor, the corresponding media address detected in step SP74 is set as the initial LBA. Subsequently, the destaging processing program 25 creates a parameter list which registers all of the LBA range descriptors that were created for each dirty data.

Moreover, the destaging processing program 25 creates a Write Scatter command which stores the number of LBA range descriptors registered in the created parameter list in the 4th to 7th bytes of FIG. 7, and stores the total data size of the respective data lengths, which were designated in the respective LBA range descriptors registered in the parameter list, in the 8th to 11th bytes of FIG. 7. Subsequently, the destaging processing program 25 sends the created Write Scatter command and parameter list to the selected storage media 5.

Subsequently, the destaging processing program 25 waits for the data transfer start notice described with regard to steps SP18A, SP18B of FIG. 2 to be sent from the target storage media 5 (SP77), and, when the data transfer start notice is eventually sent from the target storage media 5, reads the respective data stored in the storage area in the cache memory area 14A of the memory 14, from that cache memory area 14A, which is identified by the respective target memory addresses for which the association with the address in the target storage media 5 was stored in step SP74, and transfers the read to the target storage media 5 according to the data format shown in FIG. 10 (SP78).

The destaging processing program 25 thereafter waits for the storage completion notice explained with reference to steps SP20A, SP20B of FIG. 2 to be sent from the target storage media 5 (SP79), and, when the storage completion notice is eventually sent from the selected storage media 5, sets “Clean” for the respective values stored in the status column 20E (FIG. 5) of the respective entries corresponding to each data that was transferred to the selected storage media 5 in step SP78 among the entries (lines) of the cache management information 20 (SP80). The destaging processing program 25 thereafter ends this destaging processing.

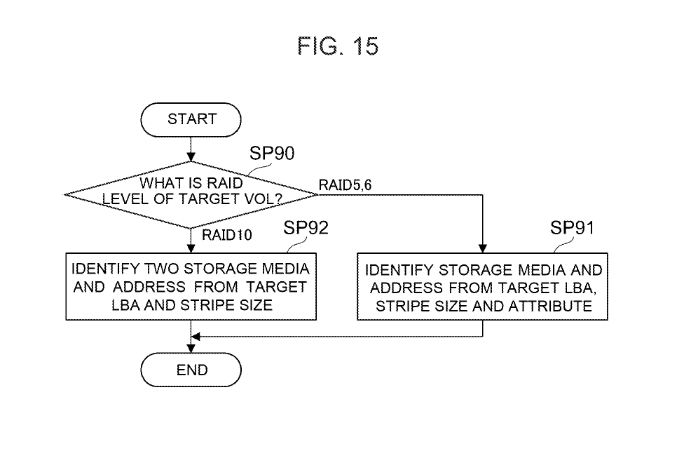

The specific processing contents of the media address detection processing to be executed by the destaging processing program 25 in step SP74 of the foregoing destaging processing are shown in FIG. 15. In the ensuing explanation also, let it be assumed that the RAID level of the RAID group RG is set to one among “RAID10”, “RAID5” and “RAID6”.

The destaging processing program 25 starts the media address detection processing upon proceeding to step SP74 of the destaging processing, and foremost refers to the map information 21 and determines the RAID level of the logical volume VOL into which the dirty data stored at the selected cache memory address in the cache memory area 14A of the memory 14 was written (SP90).

When the destaging processing program 25 recognizes that the RAID level of the logical volume VOL is RAID5 or RAID6 in this determination, the destaging processing program 25 refers to the cache management information 20 and the map information 21 and identifies the address (media address) in the selected storage media 5 to store the dirty data based on the initial LBA of the storage area in the logical volume VOL into which the dirty data was written, the stripe size that is defined with regard to that logical volume VOL, and the attribute of that dirty data (SP91). The destaging processing program 25 thereafter ends this media address identification processing, and proceeds to step SP75 of the destaging processing.

Meanwhile, when the destaging processing program 25 recognizes that the RAID level of the logical volume VOL is RAID10 in the determination of step SP50, the destaging processing program 25 refers to the cache management information 20 and the map information 21 and identifies the other storage media 5 to store the dirty data based on the initial LBA of the storage area in the logical volume VOL into which the dirty data was written and the stripe size that is defined with regard to that logical volume VOL, and identifies that storage media 5 and the address (media address) to store that dirty data in the selected storage media 5 (SP92). The destaging processing program 25 thereafter ends this media address identification processing, and proceeds to step SP75 of the destaging processing.

### (1-6) Effect of this Embodiment

According to the foregoing computer system 1, the storage controller 4 can perform the reading/writing of data from and to a plurality of storage areas in the storage media 5 by issuing a single command. Accordingly, it is possible to reduce the processing load of the storage controller 4 related to the read processing and the write processing, and consequently improve the throughout performance of the overall storage apparatus 3.

### (2) Second Embodiment

### (2-1) Configuration of Computer System According to this Embodiment

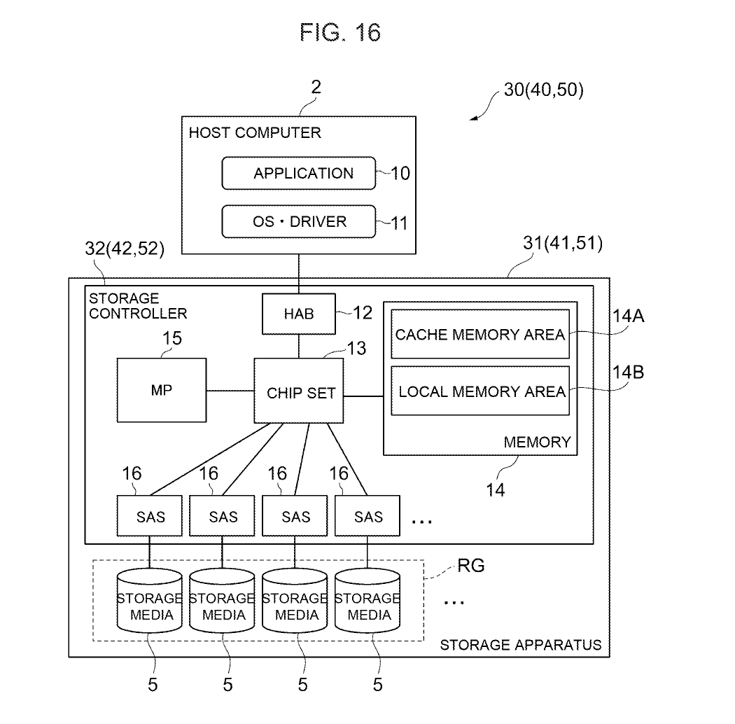

FIG. 16, in which the components corresponding to those of FIG. 1 are given the same reference numeral, shows the computer system 30 according to the second embodiment. The computer system 30 differs substantially from the computer system 1 according to the first embodiment with respect to the point that the storage apparatus 31 is equipped with a virtualization function.

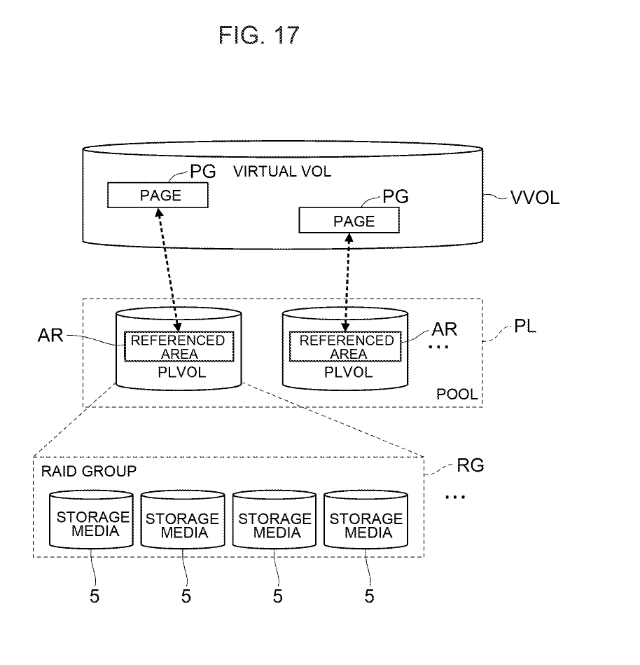

In effect, in this embodiment, the storage controller 32 of the storage apparatus 31 manages, as a pool volume PLVOL, the physical storage area provided by the RAID group RG configured from a plurality of storage media 5 as shown in FIG. 17, and collectively manages one or more pool volumes PLVOL as a pool PL.

Moreover, the storage controller 32 provides a virtual logical volume (this is hereinafter referred to as the “virtual volume”) VVOL to the host computer 2, and, when data is written from the host computer 2 into the virtual volume VVOL, assigns a referenced area AR of a predetermined size from one of the pool volumes PLVOL in the pool to the storage area (this is hereinafter referred to as the “page”) PG into which the data in the virtual volume VVOL was written, and stores the written data in the referenced area AR. This virtualization function is a technique that is referred to as Thin Provisioning, and the second embodiment is an embodiment that is compliant with Thin Provisioning.

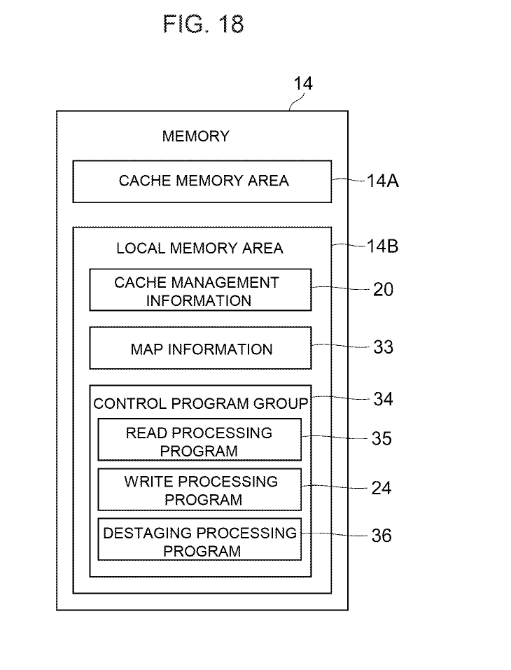

FIG. 18 shows the memory configuration of the storage apparatus 31 according to this embodiment. This computer system 30 is the same as the first embodiment with respect to the point that the storage area of the memory 14 is divided into a cache memory area 14A and a local memory area 14B, the point that the cache memory area 14A temporarily stores data to be exchanged between the host computer 2 and the storage media 5, and the point that the local memory area 14B stores the cache management information 20 and the map information 33. Moreover, this computer system 30 is the same as the first embodiment with respect to the point that the local memory area 14B stores the read processing program 35, the write processing program 24 and the destaging processing program 36 as the control program group 34.

However, this computer system 30 differs from the first embodiment with regard to the configuration of the map information 33, and the functions of the read processing program 35 and the destaging processing program 36 (that is, the processing contents of the read processing to be executed by the read processing program 35 and the processing contents of the destaging processing to be executed by the destaging processing program 36). While the functions of the read processing program 35 and the destaging processing program 36 will be described later, the configuration of the map information 33 of this embodiment is now explained.

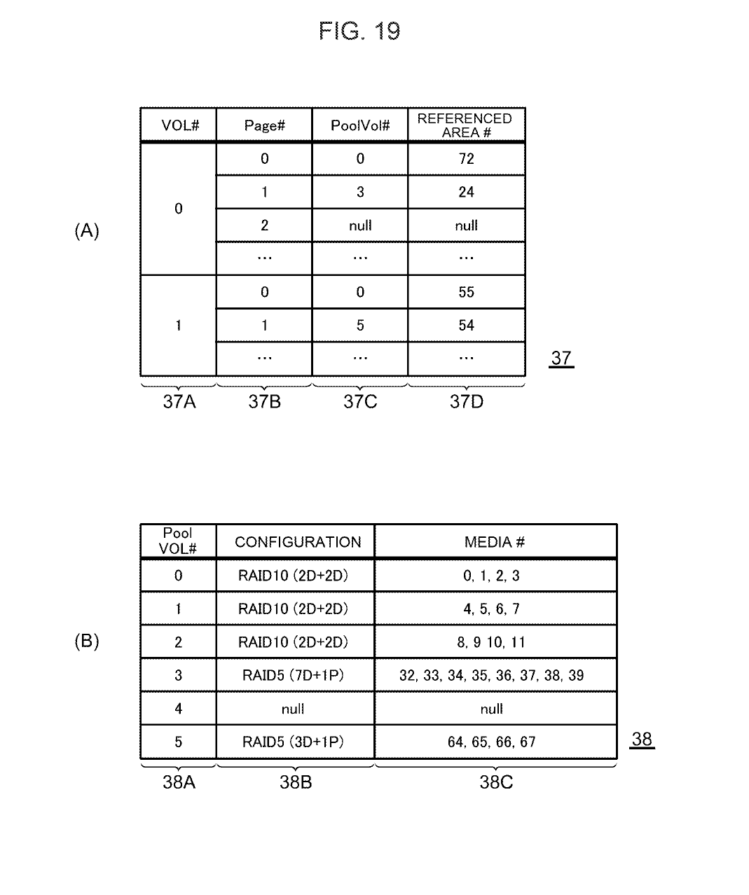

The map information 33 of this embodiment is configured, as shown in FIG. 19, from a virtual volume management table 37 and a pool volume configuration management table 38.

The virtual volume management table 37 is a table that is used for managing the virtual volumes VVOL that are provided from the storage apparatus 31 to the host computer 2, and is configured, as shown in FIG. 19(A), from a volume number column 37A, a page number column 37B, a pool volume number column 37C and a referenced area number column 37D.

The volume number column 37A stores the volume number of the respective virtual volumes WOL that are provided by the storage apparatus 31 to the host computer 2, and the page number column 37B stores the identification number (page number) that is assigned to each of the pages PG in the corresponding virtual volume VVOL.

Moreover, when a referenced area AR is assigned to the corresponding page PG in the corresponding virtual volume WOL (that is, when data from the host computer 2 is written into that page PG), the pool volume number column 37C stores the identifier (pool volume number) of the pool volume PLVOL to provide that referenced area AR, and the identifier (referenced area number) of that referenced area AR is stored in the referenced area number column 37D.

Accordingly, the example of FIG. 19(A) shows that the referenced area AR with the reference area number of “72” is assigned from the pool volume PLVOL with the pool volume number of “0” to the page PG with the page number of “0” in the virtual volume WOL to which the volume number of “0” was assigned.

Note that, with regard to a page PG in the virtual volume WOL to which a referenced area AR has not been assigned in the virtual volume management table 37, “null” implying that no information exists is stored in the pool volume number column 37C and the referenced area number column 37D, respectively.

Meanwhile, the pool volume configuration management table 38 is a table that is used for managing the pool volumes PLVOL created in the storage apparatus 31, and is configured, as shown in FIG. 19(B), from a pool volume number column 38A, a configuration column 38B and a media number column 38C.

The pool volume number column 38A stores the pool volume number of the respective pool volumes PLVOL created in the storage apparatus 31, and the configuration column 38B stores the RAID configuration of the RAID group RG that is providing the corresponding pool volumes PLVOL. Moreover, the media number column 38C stores the media number of all storage media 5 configuring the RAID group RG that is providing the corresponding pool volumes PLVOL.

Accordingly, the example of FIG. 19(B) shows that, for example, the pool volume PLVOL with the pool volume number of “0” is a storage area that is provided by the RAID group RG having the RAID configuration of “RAID10 (2D+2D)” configured from four storage media 5 which are each assigned the storage media number of “0”, “1”, “2” and “3”.

Note that, when a pool volume PLVOL to which a corresponding pool volume number is assigned is not defined in the pool volume configuration management table 38, the configuration column 38B and the media number column 38C respectively store “null” implying that no information exists.

### (2-2) Various Types of Processing Related to I/O

The specific processing contents of the read processing and the destaging processing to be executed by the storage apparatus 31 of the computer system 30 are now explained. Note that, since the processing contents of the write processing to be executed by the storage apparatus 31 of the computer system 30 are the same as the write processing of the first embodiment explained with reference to FIG. 13, the explanation thereof is omitted.

### (2-2-1) Read Processing

The read processing is foremost explained. The processing contents of the read processing to be executed by the read processing program 35 (FIG. 4) loaded in the storage apparatus 31 of the computer system 30 are basically the same as the read processing of the first embodiment explained with reference to FIG. 11.

However, with the computer system 30, since the storage apparatus 31 provides a virtual volume VVOL to the host computer 2, the processing contents of the storage media and address identification processing that is executed in step SP33 of FIG. 11 differ from the first embodiment.

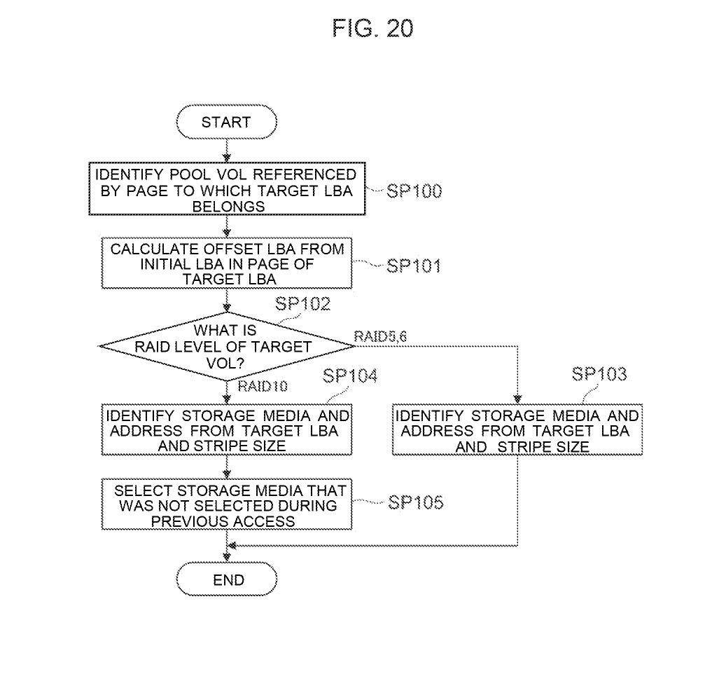

FIG. 20 shows the processing routine of the media and address identification processing according to this embodiment to be executed by the read processing program 35 of this embodiment in step SP33 of FIG. 11 in substitute for the media and address identification processing explained with reference FIG. 12. In the ensuing explanation, let it be assumed that the RAID level of the RAID group RG is set to one among “RAID10”, “RAID5” and “RAID6”.

The read processing program 35 of this embodiment starts the media and address identification processing shown in FIG. 20 upon proceeding to step SP33 of FIG. 11, and foremost refers to the virtual volume management table 37 (FIG. 19(A)), and identifies the pool volume PLVOL that is assigning the referenced area AR to the page PG to which belongs the LBA in the virtual volume VVOL that was designated as the initial LBA of the read destination of data in the LBA range descriptor (selected LBA range descriptor) selected in step SP30 of the read processing (SP100).

Subsequently, the read processing program 35 calculates the offset from the initial LBA of the page PG to which belongs the LBA in the virtual volume WOL that was designated as the initial LBA of the read destination of data in the selected LBA range descriptor, to that LBA (number of LBAs from the initial LBA of the page PG to that LBA) (SP101).

Subsequently, the read processing program 35 refers to the pool volume configuration management table 38 (FIG. 19(B)), and determines the RAID level of the pool volume PLVOL that was identified in step SP100 (SP102).

When the read processing program 35 recognizes that the RAID level of the pool volume PLVOL is RAID5 or RAID6 in this determination, the read processing program 35 identifies the storage media 5 that is actually storing the selected data registered in the LBA range descriptor and the address in that storage media 5 based on the offset calculated in step SP101 and the stripe size that is defined with regard to that pool volume PLVOL (SP103). The read processing program 35 thereafter ends this media and address identification processing, and proceeds to step SP34 of the read processing (FIG. 11).

Meanwhile, when the read processing program 35 recognizes that the RAID level of the pool volume PLVOL is RAID10 in the determination of step SP102, the read processing program 35 identifies the storage media 5 that is actually storing the selected data registered in the LBA range descriptor and the address in that storage media 5 based on the offset calculated in step SP101 and the stripe size that is defined with regard to that pool volume PLVOL (SP104).

Moreover, the read processing program 35 determines the storage media 5 that was not selected in the previous read processing among the plurality of storage media 5 identified in step SP104 as the storage media 5 that is actually storing the selected data registered in the LBA range descriptor (SP105).

The read processing program 35 thereafter ends this media and address identification processing, and proceeds to step SP34 of the read processing (FIG. 11).

### (2-2-2) Destaging Processing

The destaging processing is now explained. The processing contents of the destaging processing to be executed by the destaging processing program 36 (FIG. 18) loaded in the storage apparatus 31 of the computer system 30 are basically the same as the destaging processing of the first embodiment explained with reference to FIG. 14.

However, with the computer system 30, since the storage apparatus 31 provides a virtual volume VVOL to the host computer 2, the processing contents of the storage media address detection processing that is executed in step SP74 of FIG. 14 differ from the first embodiment.

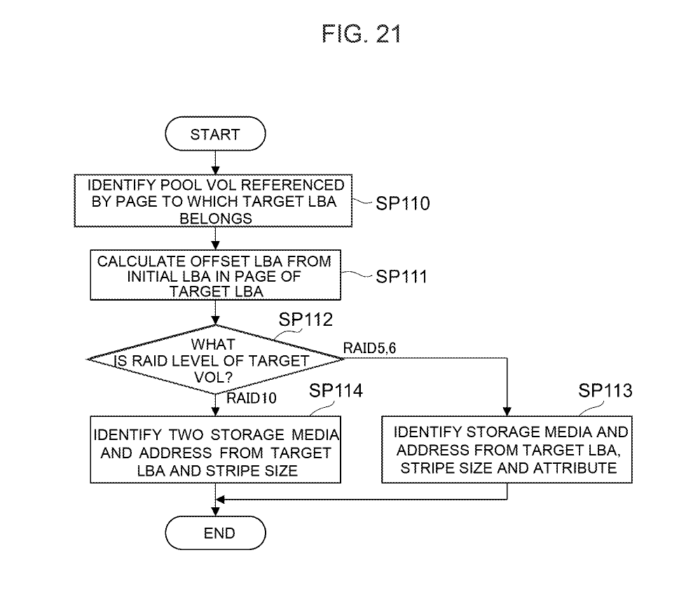

FIG. 21 shows the processing routine of the media address detection processing according to this embodiment to be executed by the destaging processing program 36 of this embodiment in step SP74 of FIG. 14 in substitute for the media address detection processing explained with reference FIG. 12. In the ensuing explanation, let it be assumed that the RAID level of the RAID group RG is set to one among “RAID10”, “RAID5” and “RAID6”.

The destaging processing program 36 of this embodiment starts the media address detection processing shown in FIG. 21 upon proceeding to step SP74 of FIG. 14, and foremost performs the processing of step SP110 and step SP111 in the same manner as step SP100 and step SP101 of the media and address identification processing explained with reference to FIG. 20.

Subsequently, the destaging processing program 36 refers to the pool volume configuration management table 38 (FIG. 19(B)), and determines the RAID level of the pool volume PLVOL that was identified in step SP100 (SP112).

When the destaging processing program 36 recognizes that the RAID level of the pool volume PLVOL is RAID5 or RAID6 in this determination, the destaging processing program 36 identifies the address in the selected storage media 5 to store the dirty data based on the offset calculated in step SP111 and the stripe size that is defined with regard to that pool volume PLVOL (SP113). The destaging processing program 36 thereafter ends this media address identification processing, and proceeds to step SP75 of the destaging processing (FIG. 14).

Meanwhile, when the destaging processing program 36 recognizes that the RAID level of the pool volume PLVOL is RAID10 in the determination of step SP112, the destaging processing program 36 identifies the other storage media 5 to store the target dirty data and the address (media address) in that storage media 5 and the selected storage media 5 to store that dirty data based on the offset calculated in step SP111 and the stripe size that is defined with regard to that pool volume PLVOL (SP114). The destaging processing program 36 thereafter ends this media address identification processing, and proceeds to step SP75 of the destaging processing (FIG. 14).

### (2-3) Effect of this Embodiment

As described above, according to the foregoing computer system 30, as with the computer system 1 according to the first embodiment, the storage controller 32 can perform the reading/writing of data from and to a plurality of storage areas in the storage media 5 by issuing a single command. Consequently, it is possible to reduce the processing load of the storage controller 42 related to the read processing and the write processing even with regard to the host computer 30 equipped with the Thin Provisioning virtualization function, and thus improve the throughout performance of the overall storage apparatus 31.

### (3) Third Embodiment

FIG. 16 shows the overall computer system 40 according to the third embodiment. This computer system 40 is configured the same as the computer system 30 according to the second embodiment excluding the point that the first data relocation function described later is loaded in the storage apparatus 41 (FIG. 16).

The first data relocation processing function is now explained. In the computer system 30 according to the second embodiment, the storage apparatus 31 that received the Read Gather command and the parameter list from the host computer 2 needs to read, from the corresponding storage media 5, data that is not stored in the cache memory area 14A of the memory among the plurality of data that were designated in the parameter list.

In the foregoing case, if read-target data in the same parameter list that are read at a high frequency are stored in the storage media 5, it is considered that staging can be performed more efficiently in comparison to the case of such data being distributed and stored in a plurality of storage media 5.

Thus, with the computer system 40 according to this embodiment, the storage apparatus 41 is equipped with the foregoing first data relocation function of detecting the data pair (pair) in the same parameter list, which is sent from the host computer 2 to the storage apparatus 41, that is to be subject to reading/writing at a high frequency, and relocating such data to the same storage media 5.

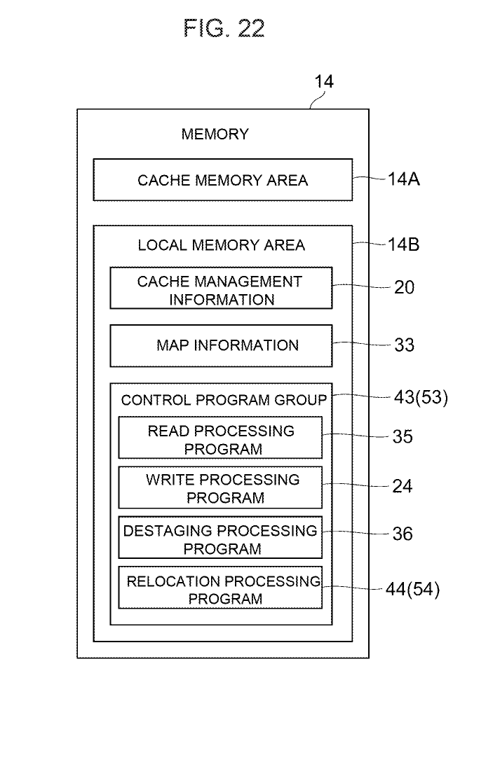

In effect, as the means for exhibiting the foregoing first data relocation function in the storage apparatus 41 of this embodiment, as shown in FIG. 22 in which the components corresponding to those of FIG. 18 are given the same reference numeral, the local memory area 14B of the memory 14 of the storage controller 42 stores a first relocation processing program 44 in addition to the read processing program 35, the write processing program 24 and the destaging processing program 36 as the control program group 43.

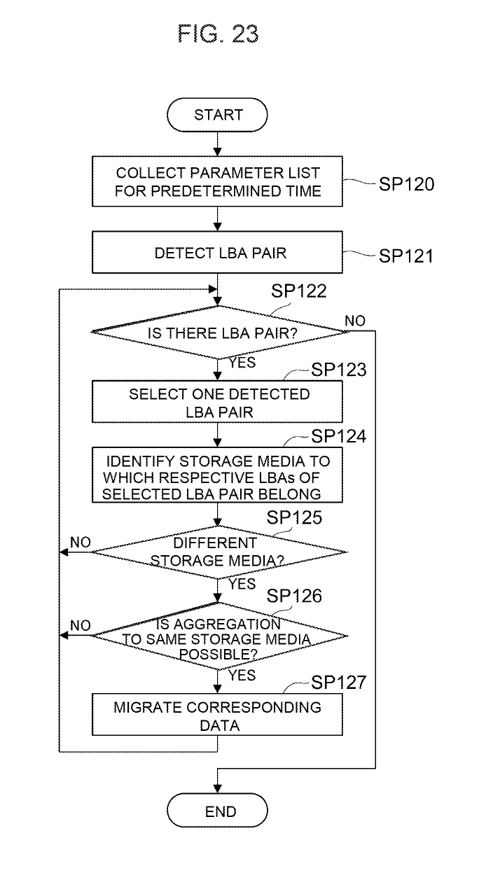

By periodically or randomly executing the first data relocation processing shown in FIG. 23, the first relocation processing program 44 detects the data pair in the same parameter list, which is sent from the host computer 2 to the storage apparatus 41, that is to be subject to reading/writing at a high frequency, and relocates such data to the same storage media 5.

In other words, when the first relocation processing program 44 starts the first data relocation processing shown in FIG. 23, the first relocation processing program 44 foremost collects the parameter lists of a predetermined time (for example, several minutes) that were sent from the host computer 2 together with the Read Gather command or the Write Scatter command (SP120).

Subsequently, the first relocation processing program 44 refers to the respective LBA range descriptors that are registered in each of the parameter lists collected in step SP120, and detects all pairs of the LBAs in the same virtual volume WOL (these are hereinafter referred to as the “LBA pairs”) that were designated as the initial LBA of the read source or the write destination of a high frequency (frequency of a predetermined threshold or more) in the same parameter list (SP121).

Subsequently, the first relocation processing program 44 determines whether there is an unprocessed LBA pair among those detected in step SP121 which has not yet been subject to the processing of step SP124 onward (SP122). When the first relocation processing program 44 obtains a positive result in this determination, the first relocation processing program 44 selects one LBA pair among the unprocessed LBA pairs that were detected in step SP121 which have not yet been subject to the processing of step SP124 onward (SP123).

In addition, the first relocation processing program 44 refers to the map information 33 (FIG. 19), and identifies the storage media 5 that are associated with the respective LBAs configuring the LBA pair selected in step SP121 (that is, the storage media 5 that are providing the reference area AR assigned to those LBAs in the virtual volume WOL) (SP124).

Moreover, the first relocation processing program 44 determines whether the storage media 5 that are associated with the respective LBAs configuring the LBA pair selected in step SP123 are different storage media based on the identification result of step SP124 (SP125).

When the first relocation processing program 44 obtains a negative result in this determination, the first relocation processing program 44 returns to step SP122. Meanwhile, when the first relocation processing program 44 obtains a positive result in the determination of step SP125, the first relocation processing program 44 determines whether it is possible to consolidate, in the same storage media, the data that are respectively stored in the storage areas designated in the respective LBAs in the virtual volume WOL configuring the LBA pair selected in step SP123 (SP126).

When the first relocation processing program 44 obtains a negative result in this determination, the first relocation processing program 44 returns to step SP122. Meanwhile, when the first relocation processing program 44 obtains a positive result in the determination of step SP126, the first relocation processing program 44 executes the data migration processing of migrating, to the same storage media 5, the data that are respectively stored in the storage areas designated in the respective LBAs in the virtual volume VVOL configuring the LBA pair selected in step SP123 (SP127).

Specifically, the first relocation processing program 44 controls the corresponding storage media 5 via the disk adapter 16 so as to migrate one data that is stored in the storage areas designated in the respective LBAs in the virtual volume WOL configuring the LBA pair selected in step SP123 to the storage media 5 that is storing the other data, or to migrate both data to another same storage media 5. Moreover, the first relocation processing program 44 simultaneously updates the virtual volume management table 37 configuring the map information 33 to the state after the foregoing data migration.

When the first relocation processing program 44 finishes the data migration processing described above, the first relocation processing program 44 returns to step SP122, and thereafter repeats the processing of step SP122 to step SP127 while sequentially switching the LBA pair selected in step SP123 to another unprocessed LBA pair.

When the first relocation processing program 44 eventually obtains a positive result in step SP122 as a result of executing the processing of step SP124 onward for all LBA pairs detected in step SP121, the first relocation processing program 44 ends this first data relocation processing.

As described above, with the computer system 40 according to this embodiment, since the data pair in the same parameter list, which is sent from the host computer 2 to the storage apparatus 41, that is to be subject to reading/writing at a high frequency is detected, and such data are relocated to the same storage media 5, staging can be performed more efficiently in comparison to the computer system 30 according to the second embodiment. Consequently, it is possible to reduce the processing load of the storage controller 42 related to the read processing and the write processing, and thus further improve the throughout performance of the overall storage apparatus 41 in comparison to the computer system 30 of the second embodiment.

### (4) Fourth Embodiment

FIG. 16 shows the overall computer system 50 according to the third embodiment. This computer system 50 is configured the same as the computer system 30 according to the second embodiment excluding the point that the second data relocation function described later is loaded in the storage apparatus 51 (FIG. 16).

The second data relocation function is now explained. The performance of the read processing using the foregoing Read Gather command in the computer system 30 according to the second embodiment is dependent on the response performance of the storage media 5 with the lowest response performance among the storage media 5 that are respectively storing each data designated in the parameter list.

For example, in a case where the plurality of read-target data designated in the Read Gather command and the parameter list sent from the host computer 2 to the storage apparatus 31 are distributed and stored in a plurality of types of storage media 5 respectively having different response performances, the storage controller 32 needs to wait for the data transfer from the storage media 5 having the lowest response performance in order to read all such data from each of the corresponding storage media 5 and transfer the read data to the host computer 2.

Accordingly, in the computer system 30 according to the second embodiment, it is desirable for data that are designated in the same Read Gather parameter command as read-target data of a high frequency to be stored in the same type of storage media 5, and it is considered that the delay in the read processing of the overall storage apparatus 31 caused by the reading of data from the storage media 5 having a low response performance can thereby be effectively prevented.

Thus, with the computer system 50 according to this embodiment, the storage apparatus 51 is equipped with the second data relocation function of detecting the data pair in the same parameter list, which is sent from the host computer 2 to the storage apparatus 41, that is to be subject to reading/writing at a high frequency, and relocating such data to the same type of storage media 5.

In effect, as the means for exhibiting the foregoing second data relocation function in the storage apparatus 51 of this embodiment, as shown in FIG. 22, the local memory area 14B of the memory 14 of the storage controller 42 stores a second relocation processing program 54 in addition to the read processing program 35, the write processing program 24 and the destaging processing program 36 as the control program group 53.

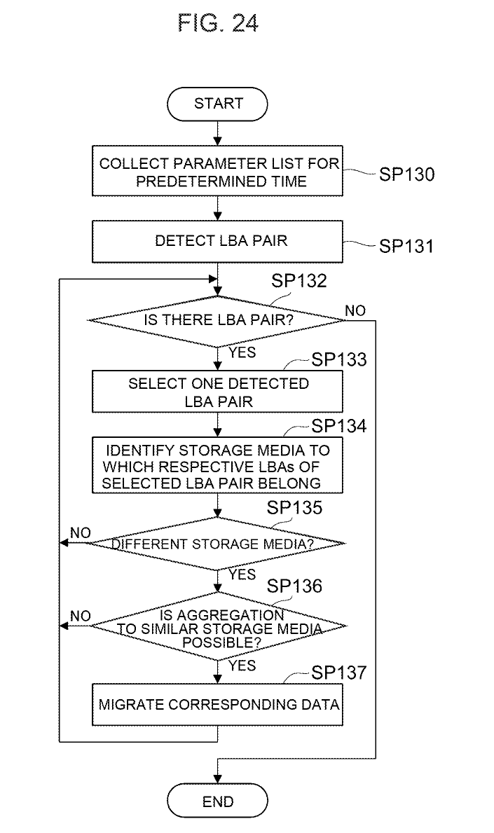

By periodically or randomly executing the second data relocation processing shown in FIG. 24, the second relocation processing program 54 detects the data pair in the same parameter list, which is sent from the host computer 2 to the storage apparatus 41, that is to be subject to reading/writing at a high frequency, and relocates such data to the same type of storage media 5.

In other words, when the second relocation processing program 54 starts the second data relocation processing shown in FIG. 24, the second relocation processing program 54 foremost collects the parameter lists (Read Gather parameter lists or Write Scatter parameter lists) of a predetermined time (for example, several minutes) that were sent from the host computer 2 (SP130).

Subsequently, the second relocation processing program 54 refers to the respective LBA range descriptors that are registered in each of the parameter lists collected in step SP130, and detects all pairs of the LBAs in the same virtual volume WOL (these are hereinafter referred to as the “LBA pairs”) that were designated as the initial LBA of the read source or the write destination of a high frequency (frequency of a predetermined threshold or more) in the same parameter list (SP131).

Subsequently, the second relocation processing program 54 determines whether there is an unprocessed LBA pair among those detected in step SP131 which has not yet been subject to the processing of step SP134 onward (SP132). When the second relocation processing program 54 obtains a positive result in this determination, the second relocation processing program 54 selects one LBA pair among the unprocessed LBA pairs that were detected in step SP131 which have not yet been subject to the processing of step SP134 onward (SP133).

In addition, the second relocation processing program 54 refers to the map information 33 (FIG. 19), and identifies the storage media 5 that are associated with the respective LBAs configuring the LBA pair selected in step SP131 (that is, the storage media 5 that are providing the reference area AR assigned to those LBAs in the virtual volume WOL) (SP134).

Moreover, the second relocation processing program 54 determines whether the storage media 5 that are associated with the respective LBAs configuring the LBA pair selected in step SP133 are different storage media based on the identification result of step SP134 (SP135). Note that, in this embodiment, let it be assumed that the storage controller 42 of the storage apparatus 51 is storing the individual types of storage media 5 in advance.

When the second relocation processing program 54 obtains a negative result in this determination, the second relocation processing program 54 returns to step SP132. Meanwhile, when the second relocation processing program 54 obtains a positive result in the determination of step SP135, the second relocation processing program 54 determines whether it is possible to consolidate, in the same type of storage media, the data that are respectively stored in the storage areas designated in the respective LBAs in the virtual volume WOL configuring the LBA pair selected in step SP133 (SP136).

When the second relocation processing program 54 obtains a negative result in this determination, the second relocation processing program 54 returns to step SP132. Meanwhile, when the second relocation processing program 54 obtains a positive result in the determination of step SP136, the second relocation processing program 54 executes the data migration processing of migrating, to the same type of storage media 5, the data that are respectively stored in the storage areas designated in the respective LBAs in the virtual volume VVOL configuring the LBA pair selected in step SP133 (SP137).

Specifically, the second relocation processing program 54 controls the corresponding storage media 5 via the disk adapter 16 so as to migrate one data that is stored in the storage areas designated in the respective LBAs in the virtual volume WOL configuring the LBA pair selected in step SP133 to the same type of storage media 5 that is storing the other data, or to migrate both data to another storage media 5 of the same type. Moreover, the second relocation processing program 54 simultaneously updates the virtual volume management table 37 configuring the map information 33 to the state after the foregoing data migration.

Subsequently, when the second relocation processing program 54 finishes the data migration processing described above, the second relocation processing program 54 returns to step SP132, and thereafter repeats the processing of step SP132 to step SP137 while sequentially switching the LBA pair selected in step SP133 to another unprocessed LBA pair.

When the second relocation processing program 54 eventually obtains a positive result in step SP132 as a result of executing the processing of step SP134 onward for all LBA pairs detected in step SP131, the second relocation processing program 54 ends this second data relocation processing.

As described above, with the computer system 50 according to this embodiment, since the data pair in the same parameter list, which is sent from the host computer 2 to the storage apparatus 51, to be subject to reading/writing at a high frequency is detected, and such data are relocated to the same type of storage media 5, the delay in the read processing of the overall storage apparatus 31 caused by the reading of data from the storage media 5 having a low response performance can thereby be effectively prevented. Consequently, it is possible to further improve the throughout performance of the overall storage apparatus 51 in comparison to the computer system 30 of the second embodiment.

### (5) Other Embodiments

Note that, while the first to fourth embodiments described above explained cases of applying the present invention to the storage apparatuses 3, 31, 41, 51 configured as shown in FIG. 1 or FIG. 16, the present invention is not limited thereto, and may also be broadly applied to other storage apparatuses of various configurations.

Moreover, while the first to fourth embodiments described above explained cases of creating and sending, according to the command format prescribed in FIG. 7 to FIG. 9, a first read command that is sent from the host computer 2 to the storage apparatuses 3, 31, 41, 51 and which designates, as the read destination, a plurality of storage areas in the logical volume VOL or the virtual volume WOL of those storage apparatuses 3, 31, 41, 51, a second read command that is sent from the storage controllers 4, 32, 42, 52 to the respective storage media 5 and which designates, as the read destination, a plurality of storage areas in that storage media 5, and a first write command that is sent from the storage controllers 4, 32, 42, 52 to the respective storage media 5 and which designates, as the write destination, a plurality of storage areas in that storage media 5, the present invention is not limited thereto, and other various formats may be broadly applied as the command format of the first and second read commands and the first write command.

Moreover, while the third and fourth embodiments described above explained cases of configuring the computer systems 40, 50 by loading either the first or second data relocation function in the computer system 30 of the second embodiment, the present invention is not limited thereto, and both the first and second data relocation functions may be loaded in the computer system 30 of the second embodiment.

In addition, while the fourth embodiment described above explained a case of simply storing, in step SP137 of the second data relocation processing, each data stored in the storage areas of the virtual volume WOL identified by the respective LBAs configuring the LBA pair in the same type of storage media 5, the present invention is not limited thereto and, for example, it is also possible to select the type of storage media 5 having a response performance that is compliant with the access frequency of such data, and relocating such data to the storage media 5 of that type.

The foregoing case can be realized by the storage controller 42 constantly measuring the access frequency of all data stored in the respective storage media 5, and the storage controller 42 determining the relocation destination of the data so that the second relocation processing program 54 uses data with a higher access frequency as the reference based on the access frequency of such data, and relocates data with higher access frequency to a storage media 5 with a higher response performance.

### REFERENCE SIGNS LIST

1, 30, 40, 50 . . . computer system, 2 . . . host computer, 3, 31, 41, 51 . . . storage apparatus, 4, 32, 42, 52 . . . storage controller, 5 . . . storage media, 14 . . . memory, 14A . . . cache memory area, 14B . . . local memory area, 15 . . . microprocessor, VOL . . . logical volume, WOL . . . virtual volume, 20 . . . cache management information, 21, 33 . . . map information, 22, 34, 43, 53 . . . control program group, 23, 35 . . . read processing program, 24 . . . write processing program, 25, 36 . . . destaging processing program, 37 . . . virtual volume management table, 38 . . . pool volume configuration management table, 44, 54 . . . relocation processing program, PL . . . pool volume, PLVOL . . . pool volume, RG . . . RAID group.

1. A storage apparatus, comprising:
a plurality of storage media; and
a storage controller that controls input/output of data to and from the storage media,
wherein the storage controller:
provides a logical volume to a connected host computer, and, upon receiving a first read command that is sent from the host computer and which designates a plurality of storage areas in the logical volume as a read destination, identifies the storage media that is actually storing the data written into the storage area and an address in the storage media for each of the storage areas in the logical volume that was designated as the read destination, and
creates, for each of the storage media, a second read command that designates a part or all of each of the identified addresses in the identified storage media as a read destination, and sends each of the created second read commands to the corresponding storage media,
wherein each of the storage media that received the second read command reads data from each of the addresses designated in the received second read command and sends the read data to the storage controller, and
wherein the storage controller transfers, to the host computer, the data that was read from each of the addresses designated in the second read command and sent from each of the storage media that sent the second read command.

2. The storage apparatus according to claim 1,
wherein the storage controller:
includes a cache area for temporarily storing data to be input/output to and from the storage media, and
creates the second read command that designates, as a read destination, the address in the storage media corresponding to each of the storage areas, in which data stored in the storage area is not stored in the cache area, among the storage areas in the logical volume that was designated as a read destination in the first read command.

3. The storage apparatus according to claim 1,
wherein the storage controller:
includes a cache area for temporarily storing data to be input/output to and from the storage media,
with regard to each data that is not stored in the storage media among the data stored in the cache area, periodically or randomly detects the storage media to store that data and a storage area in that storage media, respectively, and
creates, for each of the storage media, a first write command that respectively designates a write destination of each data to be stored from the cache area into the storage media based on a detection result, and respectively sends the created first write command and each data in which the write destination thereof is designated in that first write command to the corresponding storage media.

4. The storage apparatus according to claim 1,
wherein the logical volume is a virtual logical volume, and
wherein the storage controller:
manages a storage area of the plurality of storage media as a pool, and
dynamically assigns a storage area from the pool to the logical volume according to a write request from the host computer for writing data into that logical volume, and stores write-target data in the assigned storage area.

5. The storage apparatus according to claim 4,
wherein the storage controller:
detects a pair of the data that is designated as a read-target at a high frequency in the same first read command, and
controls the corresponding storage media so that each of the data configuring that pair is relocated to the same storage media.

6. The storage apparatus according to claim 4,
wherein the storage controller:
detects a pair of the data that is designated as a read-target at a high frequency in the same first read command, and
controls the corresponding storage media so that each of the data configuring that pair is relocated to the same type of storage media.

7. A data input/output method of inputting/outputting data to and from a storage media to be executed in a storage apparatus including a plurality of storage media, and a storage controller that controls input/output of data to and from the storage media, the data input/output method comprising:
a first step of the storage controller providing a logical volume to a connected host computer, and, upon receiving a first read command that is sent from the host computer and which designates a plurality of storage areas in the logical volume as a read destination, identifying the storage media that is actually storing the data written into the storage area and an address in the storage media for each of the storage areas in the logical volume that was designated as the read destination;
a second step of the storage controller creating, for each of the storage media, a second read command that designates a part or all of each of the identified addresses in the identified storage media as a read destination, and sending each of the created second read commands to the corresponding storage media,
a third step of each of the storage media that received the second read command reading data from each of the addresses designated in the received second read command and sending the read data to the storage controller; and
a fourth step of the storage controller transferring, to the host computer, the data that was read from each of the addresses designated in the second read command and sent from each of the storage media that sent the second read command.

8. The data input/output method according to claim 7,
wherein the storage controller:
includes a cache area for temporarily storing data to be input/output to and from the storage media, and
in the second step, creates the second read command that designates, as a read destination, the address in the storage media corresponding to each of the storage areas, in which data stored in the storage area is not stored in the cache area, among the storage areas in the logical volume that was designated as a read destination in the first read command.

9. The data input/output method according to claim 7,
wherein the storage controller:
includes a cache area for temporarily storing data to be input/output to and from the storage media, and
with regard to each data that is not stored in the storage media among the data stored in the cache area, periodically or randomly detects the storage media to store that data and a storage area in that storage media, respectively, and
creates, for each of the storage media, a first write command that respectively designates a write destination of each data to be stored from the cache area into the storage media based on a detection result, and respectively sends the created first write command and each data in which the write destination thereof is designated in that first write command to the corresponding storage media.

10. The data input/output method according to claim 7,
wherein the logical volume is a virtual logical volume, and
wherein the storage controller:
manages a storage area of the plurality of storage media as a pool, and
dynamically assigns a storage area from the pool to the logical volume according to a write request from the host computer for writing data into that logical volume, and stores write-target data in the assigned storage area.

11. The data input/output method according to claim 10,
wherein the storage controller:
detects a pair of the data that is designated as a read-target at a high frequency in the same first read command, and
controls the corresponding storage media so that each of the data configuring that pair is relocated to the same storage media.

12. The data input/output method according to claim 10,
wherein the storage controller:
detects a pair of the data that is designated as a read-target at a high frequency in the same first read command, and
controls the corresponding storage media so that each of the data configuring that pair is relocated to the same type of storage media.
